(19) United States
(12) Patent Application Publication
(10) Pub. No.: US 2005/0118479 A1
(43) Pub. Date: Jun. 2, 2005

(54) Electrolyte film and solid polymer fuel cell using the same

(76) Inventors: Takeo Yamaguchi, Kawasaki-shi (JP); Shyusei Ohya, Chiba-shi (JP); Shin-ichi Nakao, Itabashi-ku (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/506,717

(22) PCT Filed: Mar. 6, 2003
(86) PCT No.: PCT/JP03/02630

(30) Foreign Application Priority Data
Mar. 7, 2002 (JP) 2002-061917
Dec. 14, 2002 (JP) 2002-372154
Feb. 14, 2003 (JP) 2003-035968

(51) Int. Cl. H01M 8/10; C08J 5/22

(52) U.S. Cl. 429/33; 521/27

(57) ABSTRACT

An electrolyte membrane having a porous base material having pores filled with a first polymer capable of conducting a proton, wherein the porous base material comprises at least one second polymer selected from the group consisting of polyimides and polyamides; and a fuel cell, particularly a solid polymer fuel cell, more specifically a direct methanol polymer fuel cell, using the electrolyte membrane. The electrolyte membrane is excellent in the inhibition of permeation of methanol, exhibits no or reduced change in its area, and is excellent in proton conductivity.

### TECHNICAL FIELD

The present invention relates generally to an electrolyte membrane and fuel cell using the electrolyte membrane, and more particularly to an electrolyte membrane and a direct methanol solid polymer fuel cell using the electrolyte membrane.

The present invention also relates to a method for producing an electrolyte membrane by filling a porous membrane with an electrolytic substance and more particularly a method for producing an electrolyte membrane by using a porous membrane as a substrate capable of evenly containing an electrolytic substance with good reproducibility and little unevenness. More specifically, the present invention relates to a method for producing an electrolyte membrane and particularly a solid polymer fuel cell and more particularly an electrolyte membrane for a direct methanol fuel cell.

### BACKGROUND ART

The recent encouraged global activities of environmental protection put strong demands for restrictions on greenhouse gases and NOx gas production. In order to reduce the total amount of such exhaust gases, practical application of fuel cell system to automobile is thought to be very useful.

Polymer electrolyte fuel cells (PEFCs) have several advantages: operative at a low temperature; high power density; and generation of water alone during power generating reaction. Among all, PEFCs using methanol as fuel are thought to be a promising power source for an electric automobile since they enables fuel supply in a liquid form like gasoline.

PEFCs are classified into two types: reformed methanol-type polymer electrolyte fuel cells which involve reforming methanol into hydrogen-containing gas using a reformer; and direct methanol polymer fuel cells (DMFCs) which utilize methanol directly without using a reformer. Practical use of direct methanol polymer fuel cells is expected due to their great advantages: 1) weight-saving is possible since direct methanol polymer fuel cells do not require a reformer; 2) resistance against frequent start and stop operations; 3) significantly improved load change response; and 4) substantially reduced catalyst poisoning.

However, although as the electrolytic substance for PEFC using methanol fuel, the electrolyte membrane is required to have the following; i) the inhibition of permeation of methanol (the electrolytic substance is impermeable to methanol); ii) durability, more particularly, heat resistance for operation at a high temperature (80° C. or higher); iii) no or reduced change in surface area following the wetting with a solution and drying at starting and stopping; iv) proton conductivity; v) thin film formability; and vi) chemical durability, any electrolyte membrane which could sufficiently satisfy these requirements has not been made available yet.

Further, in from a viewpoint of a portable type methanol fuel PEFC, i) the inhibition of permeation of methanol is important and operation-ability near a normal temperature is important, while the durability at a high temperature becomes less important.

For example, in the case of using Nafion (registered trademark) manufactured by Du Pont, Dow films manufactured by Dow Chemical Corporation, or the like, which are solid polymer electrolytic substances as the electrolytes, a problem of decrease of electromotive force owing to the permeation of the membranes with methanol is pointed out. Further, the following problem is also pointed out: the electrolyte membranes are swollen in wet state in the ambient environments of the fuel cell operation and accordingly the creep is widened to deteriorate the size stability. More, the electrolyte membranes also have a problem in terms of the economy that they are very costly.

On the other hand, it has been tried so far to provide a new function by filling and carrying different substances in pores of a porous membrane. For example, it has been known that porous polymer membranes are used as a substrate, porous membranes.

Various types of membranes have been known as these porous membranes. Many of them are inferior in any one of the heat resistance, the chemical stability, the dynamic physical properties, and the size stability. Therefore, they are known to have narrow option of the material planning.

Accordingly, it is proposed that the porous membranes prepared by using porous membranes made of liquid crystal polymers or solvent-soluble or thermoset or thermoplastic polymers as porous polymer membranes, filling polymers having proton conductivity to the membranes, and preferably thermally pressing the substrates, are suitable for the electrolyte membranes of fuel cells (U.S. Pat. No. 6,248,469). However, with respect to the above-mentioned electrolyte membranes, the polymers to be used are easy to be swollen with methanol to result in high change ratio of the thickness and the surface area. Further, since the electrolyte membranes are produced by the thermal press process, no smooth plane can be obtained and unevenness of their thickness is significant. The controllability of the thickness cannot be attained. Therefore, they are not preferable for the electrolyte membranes for fuel cells which are required to have even and controlled thickness.

In the case of producing electrolyte membranes such as electrolyte membranes for fuel cells, it is required to develop a production method by which it is made possible to contain an electrolyte membrane using a porous membrane consisting of a heat resistant polymer material as a substrate with an electrolytic substance evenly at a high reproducibility.

Further, it is required to develop a simple method for producing an excellent electrolyte membrane having characteristics required for an electrolyte, particularly an electrolyte for a fuel cell, and above all an electrolyte membrane for a direct methanol fuel cell and to develop such an electrolyte membrane for a fuel cell.

### DISCLOSURE OF INVENTION

Accordingly, an object of the present invention is to provide an electrolyte membrane satisfying the above-mentioned requirements. Particularly, the object of the present invention is to provide an electrolyte membrane excellent in i) the inhibition of permeation of methanol, iii) no or reduced change in surface area, and iv) proton conductivity.

Other than, or in addition to, the above-mentioned objects, the object of the present invention is also to provide a fuel cell having the electrolyte membrane, particularly a solid polymer fuel cell, and more particularly direct methanol solid polymer fuel cell each satisfying the requirements.

Further, the object of the present invention is also to provide a method for producing an electrolyte membrane evenly containing an electrolytic substance. That is, the object of the invention is to provide a method for producing an electrolyte membrane with little unevenness among electrolyte membranes and materials with a high reproducibility and such an excellent electrolyte membrane for a fuel cell. Further, the object of the invention is to provide an electrolyte membrane filled with an electrolytic substance, particularly an electrolyte at a desired filling ratio, and a method for producing an electrolyte membrane, for example, an electrolyte membrane for a direct methanol type fuel cell in which the methanol permeability and the proton conductivity can easily be well-balanced and which is industrially remarkably useful and its production.

More particularly, in addition to, or other than, the above-mentioned objects, the object of the present invention is to provide a method for producing an electrolyte membrane, particularly an electrolyte membrane for a fuel cell, by filling a highly heat resistant porous membrane with an electrolytic substance easily and evenly at a high filling ratio with no or reduced unevenness as well as such an electrolyte membrane for a fuel cell, an electrolyte membrane-electrode assembly, and a fuel cell each having excellent properties.

In addition to, or other than, the above-mentioned objects, the object of the present invention is to provide a method for producing an electrolyte membrane for a fuel cell which can provide improved proton conductivity owing to the size or shape stability and which is thus industrially useful.

In addition to, or other than, the above-mentioned objects, the object of the present invention is to provide a method for producing an electrolyte membrane, which comprises the step of filling pores of a porous membrane with a proton conductive substance, an electrolytic substance, by simple operation, and particularly, a method for producing an electrolyte membrane provided with excellent proton conductivity and reduced methanol permeation (cross-over) for a direct methanol fuel cell.

Further, other than the above-mentioned object, the object of the present invention is also to provide an electrolyte membrane for a fuel cell, an electrolyte membrane-electrode assembly, and a fuel cell each having excellent properties and characteristics.

The present inventors have found the following inventions based on the results of enthusiastically carried out investigations.

<1> An electrolyte membrane comprising a porous substrate, wherein pores of the substrate are filled with a first polymer having proton conductivity, and the porous substrate is comprised of a second polymer which is at least one selected from the group consisting of polyimides and polyamides.

<2> In the above item <1>, the porous substrate may be comprised of at least one selected from aromatic polyimides.

<3> In the above item <1>, the porous substrate may be comprised of at least one selected from aromatic polyamides.

<4> In any one of the above items <1> to <3>, the porous substrate may have an average pore diameter: 0.01 to 1 μm; a porosity: 20 to 80%; and a thickness: 5 to 300 μm.

<5> In any one of the above items <1> to <4>, the porous substrate may have a heat resistant temperature of 200° C. or higher and a thermal shrinkage ratio of ±1% or less in case of thermal treatment at 105° C. for 8 hours.

<6> In any one of the above items <1> to <5>, the porous substrate may have a network structure which is composed of polymer phase and void phase in inside of the substrate and forming pores penetrated through the substrate, and the porous substrate may have a porous structure in both surfaces.

<7> In any one of the above items <1> to <6>, one end of the first polymer may be bound to the inner surface of the pores of the substrate.

<8> In any one of the above items <1> to <7>, the pores of the substrate may be further filled with a third polymer having proton conductivity.

<9> In any one of the above items <1> to<8>, the electrolyte membrane may have a proton conductivity of 0.001 S/cm or more and 10.0 S/cm or less, preferably 0.01 S/cm or more and 10.0 S/cm or less, at 25° C. and 100% humidity.

<10> In any one of the above items <1> to <9>, the electrolyte membrane may have a reciprocal number of methanol permeability at 25° C. of 0.01 m²h/kgμm or more and 10.0 m²h/kgμm or less, preferably 0.01 m²h/kgμm or more and 1.0 m²h/kgμm or less.

<11> In any one of the above items <1> to <10>, the electrolyte membrane may have a ratio of change in surface area between dry and wet states at 25° C. of about 1% or less, i.e., in a range of from 0 to about 1 %.

<12> An electrolyte membrane comprising a porous substrate, wherein pores of the substrate are filled with a first polymer having proton conductivity, the porous substrate is comprised of a second polymer which is at least one selected from the group consisting of polyimides and polyamides, and the porous substrate has a ratio of change in surface area of about 1% or less between the dry and the wet states at 25° C.

<13> In the above item <12>, the electrolyte membrane may have a proton conductivity of 0.001 S/cm or more and 10.0 S/cm or less at 25° C. and 100% humidity.

<14> A fuel cell having the electrolyte membrane described in any of the above items <1> to <13>.

<15> A solid polymer fuel cell having the electrolyte membrane described in any of the above items <1> to <13>.

<16> A direct methanol solid polymer fuel cell having the electrolyte membrane described in any of the above items <1> to <13>.

<17> A solid polymer fuel cell comprising an anode, a cathode, and an electrolyte sandwiched therebetween, wherein the electrolyte comprises a porous substrate wherein pores of the substrate are filled with a first polymer having proton conductivity, and the porous substrate is comprised of a second polymer which is at least one selected from the group consisting of polyimides and polyamides.

<18> In the above item <17>, the porous substrate may be comprised of at least one selected from aromatic polyimides.

<19> In the above item <17>, the porous substrate may be comprised of at least one selected from aromatic polyamides.

<20> In any one of the above items <17> to <19>, the porous substrate may have an average pore diameter: 0.01 to 1 μm; a porosity: 20 to 80%; and a thickness: 5 to 300 μm.

<21> In any one of the above items <17> to <20>, the porous substrate may have a heat resistant temperature of 200° C. or higher and a thermal shrinkage ratio of ±1% or less in case of thermal treatment at 105° C. for 8 hours.

<22> In any one of the above items <17> to <21>, the porous substrate may have a network structure which is composed of polymer phase and void phase in inside of the substrate and forming pores penetrated through the substrate, and the porous substrate may have a porous structure in both surfaces.

<23> In any one of the above items <17> to <22>, one end of the first polymer may be bound to the inner surface of the pores of the substrate.

<24> In any one of the above items <17> to <23>, the pores of the substrate may be further filled with a third polymer having proton conductivity.

<25> In any one of the above items <17> to <24>, the electrolyte membrane may have a proton conductivity of 0.001 S/cm or more and 10.0 S/cm or less, preferably 0.01 S/cm or more and 10.0 S/cm or less, at 25° C. and 100% humidity.

<26> In any one of the above items <17> to <25>, the electrolyte membrane may have a reciprocal number of methanol permeability at 25° C. of 0.01 m²h/kgμm or more and 10.0 m²h/kgμm or less, preferably 0.01 m²h/kgμm or more and 1.0 m²h/kgμm or less.

<27> In any one of the above items <17> to <26>, the electrolyte membrane may have a ratio of change in surface area between dry and wet states at 25° C. of about 1% or less, i.e., in a range of from 0 to about 1 %.

<28> In any one of the above items <17> to <27>, the solid polymer fuel cell may be a direct methanol solid polymer fuel cell.

<29> A method for producing an electrolyte membrane which comprises a porous polyimide membrane filled with an electrolytic substance, wherein the electrolytic substance is a monomer composing a polymer having proton conductivity; and the method comprises a step of filling the monomer into pores of the membrane, and thereafter heating the monomer to polymerize the monomer.

<30> A method for producing an electrolyte membrane which comprises a porous polyimide membrane filled with an electrolytic substance, wherein the electrolytic substance is a monomer composing a polymer having proton conductivity; and after a step of filling the monomer into pores of the porous membrane, and after a step of heating the monomer to polymerize the monomer, the method further repeats the steps of filling and heating at least once, thereby a filling ratio of a filling material may be controlled.

<31> A method for producing an electrolyte membrane which comprises a porous polyimide membrane filled with an electrolytic substance, wherein the method comprises a step of heating a monomer to polymerize the monomer, combined with one step selected from the following (X-1) to (X-4) steps or combinations of two steps thereof, or three steps thereof, or all steps thereof, thereby filling the pores of the membrane with the electrolytic substance; and/or following (Y-1) step and/or (Y-2) step, after the step of filling the pores of the membrane with electrolytic substance:
(X-1) a step of making the porous membrane hydrophilic and immersing the porous membrane in a monomer or its solution;
(X-2) a step of adding a surfactant to a monomer or its solution to produce an immersion solution and immersing the porous membrane in the immersion solution;
(X-3) a step of reducing pressure in the state that the porous membrane is immersed in a monomer or its solution;
(X-4) a step of radiating ultrasonic wave in the state that the porous membrane is immersed in a monomer or its solution; and
(Y-1) a step of bringing a porous substrate for absorbing the electrolytic substance into contact with both surfaces of the porous membrane; and
(Y-2) a step of removing the electrolytic substance adhering to both surfaces of the porous membrane by a smooth material.

<32> A method for producing an electrolyte membrane which comprises a porous polyimide membrane filled with an electrolytic substance, wherein the electrolytic substance is a monomer composing a polymer having proton conductivity; and the method comprises a step of adding a surfactant to the monomer or solution thereof, to prepare an immersion solution; and a step of heating the monomer to polymerize the monomer.

<33> In any one of the above items <29> to <32>, the porous polyimide membrane may be a material which is not substantially swollen by methanol or water.

<34> In any one of the above items <29> to <33>, a radical polymerization initiator may be further contained in the monomer or the solution, in the step of adding the surfactant.

<35> In any one of the above items <29> to <34>, the electrolytic substance may be a polymer having proton conductivity; and may have a cross-linked structure by the step of heating to polymerize.

<36> In any one of the above items <29> to <35>, the electrolytic substance filled in the pores may be a proton conductive polymer; and the proton conductive polymer may be chemically bound to the interface of the porous polyimide membrane.

<37> The electrolyte membrane obtained by any method of the above items <29> to <36> may be an electrolyte membrane, in particular, an electrolyte membrane for a solid polymer fuel cell, in more particular, an electrolyte membrane for a direct methanol fuel cell, wherein pores of the membrane are filled with a proton conductive polymer.

<38> In any one of the above items <29> to <37>, the polyimide contains 3,3′,4,4′-biphenyltetracarboxylic acid dianhydride as a tetracarboxylic acid component, and oxydianiline as a diamine component, respectively.

<39> An electrolyte membrane for a fuel cell having a proton conductivity at 25° C. in 100% humidity of 0.001 S/cm or more and 10.0 S/cm or less, preferably 0.01 S/cm or more and 10.0 S/cm or less; a reciprocal number of methanol permeability at 25° C. of 0.01 m²h/kgμm or more and 10.0 m²h/kgμm or less, preferably 0.01 m²h/kgμm or more and 1.0 m²h/kgμm or less; and a ratio of change in surface area between dry and wet states at 25° C. of about 1% or less, i.e., in a range of 0 to about 1%.

<40> In the above item <39>, the polyimide comprises 3,3′,4,4′-biphenyltetracarboxylic acid dianhydride as a tetracarboxylic acid component, and oxydianiline as a diamine component, respectively, and in particular, the polyimide comprises 3,3′,4,4′-biphenyltetracarboxylic acid dianhydride and oxydianiline as main components, that is, the polyimide comprises 50 mol % or more of each of components.

<41> An electrolyte membrane-electrode assembly using the electrolyte membrane for a fuel cell described in the above <39> or <40>.

<42> A fuel cell using the electrolyte membrane-electrode assembly described in the above <41>.

### BRIEF DESCRIPTION OF DRAWINGS

FIG. 1 is a graph showing the results of measurement of a ratio of change in membrane surface area and results of measurement of proton conductivity.

FIG. 2 is a graph showing the results of evaluation of methanol permeability and results of measurement of proton conductivity.

FIG. 3 shows a correlation between current density and cell voltage (I-V curve) of a solid polymer fuel cell in Example II-5.

FIG. 4 shows a correlation between current density and cell voltage (I-V curve) of a direct methanol fuel cell in Example II-6.

FIG. 5 shows a correlation between current density and output density (I-W curve) of a direct methanol fuel cell in Example II-6.

### BEST MODE FOR CARRYING OUT THE INVENTION

Hereinafter, the invention will be described more in details.

An electrolyte membrane of the present invention comprises a porous substrate whose fine pores are filled with a first polymer having proton conductivity and the porous substrate is comprised of a second polymer which at least one selected from the group consisting of polyimides and polyamides.

The second polymer may be preferably at least one selected from polyimides and polyamides. Especially, the polymer may be preferably at least one selected from aromatic polyimides and aromatic polyamides, and more preferably from aromatic polyimides.

As used herein, polyimides, particularly aromatic polyimides may include those as follows: polyimides may be those obtained by polymerizing tetracarboxylic acid components with diamine components, preferably aromatic diamine components, to obtain polyamic acids or polyimide precursors of the partially imidated polyamic acids, and further heating or chemically treating the polyamic acids or the polyimide precursors to ring-close. The polyimides of the present invention have heat resistance. The imidation ratio may be preferably about 50% or higher, more preferably 70% or higher, and even more preferably 70 to 99%.

Also, as used herein, polyamides, particularly aromatic polyamides, may include those as follows: polyamides maybe those obtained by polymerization by acid amide bonds (—CONH—). In particular, aromatic-polyamides may be polymers having phenyl groups in main chains thereof.

The polyimides which may be used for the present invention will be described hereinafter.

Organic solvents to be used as the solvents of polyimide precursors may include p-chlorophenol, N-methyl-2-pyrrolidine (NMP), pyridine, N,N-dimethylacetamide, N,N-dimethylformamide, dimethyl sulfoxide, tetramethylurea, phenol, cresol and the like.

The tetracarboxylic acid components and diamine components are dissolved in approximately equimolecular state in the above-mentioned organic solvents, and polymerized to give polyimide precursors with a logarithmic viscosity number of (30° C., concentration: 0.5g/100 mL; NMP), that is, 0.3 or more, preferably 0.5 to 7. In the case of carrying out the polymerization at 80° C. or higher, polyimidated polyimide precursors with partial ring-closing can be obtained.

Preferable examples of the diamines may be aromatic diamine compounds defined by the following general formula (1) or (2) (in the formulas, R₁ or R₂ means hydrogen or a substituent group such as a lower alkyl group, a lower alkoxy group or the like; and A means a divalent group such as O, S, CO, SO₂, SO, CH₂, and C(CH₃)₂). Two R₁ in the general formula (1) may be same or different. Also, two R₂ in the general formula (2) may be same or different.

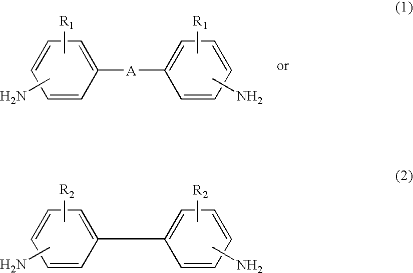

Practically, the aromatic diamine compounds may include 4,4′-diaminodiphenyl ether (hereinafter, abbreviated as DADE in some cases), 3,3′-dimethyl-4,4′-diaminodiphenyl ether, 3,3′-diethoxy-4,4′-diaminodiphenyl ether and the like. Also, the above-mentioned aromatic diamine compounds may be partially substituted with p-phenylenediamine.

Further, examples of diamines other than the above-exemplified examples may include diaminopyridine compounds defined by the following general formula (3), such as 2,6-diaminopyridine, 3,6-diaminopyridine, 2,5-daminopyridine, 3,4-diaminopyridine and the like.

The diamine components may be combinations of two or more type of the above-mentioned respective diamines.

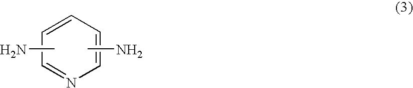

The tetracarboxylic acid components may preferably include biphenyltetracarboxylic acids. For example, 3,3′,4,4′-biphenyltetracarboxylic acid dianhydride (hereinafter, abbreviated as s-BPDA in some cases) and 2,3,3 ′,4′-biphenyltetracarboxylic acid dianhydride (hereinafter, abbreviated as a-BPDA in some cases) may be preferable, and 2,3,3′,4′- or 3,3′,4,4′-biphenyltetracarboxylic acid or 2,3,3′,4′- or 3,3′,4,4′-biphenyltetracarboxylic acid salt or its ester derivative may be preferable. The biphenyltetracarboxylic acid components may be mixtures of the above-mentioned tetracarboxylic acids.

Other than the above-mentioned biphenyltetracarboxylic acids, the tetracarboxylic acid components may be aromatic tetracarboxylic acids such as pyromellitic acid, 3,3′,4,4′-benzophenonetetracarboxylic acid, 2,2-bis(3,4-dicarboxyphenyl)propane, bis(3,4-dicarboxyphenyl)sulfone, bis(3,4-dicarboxyphenyl)ether, bis(3,4-dicarboxylphenyl)thioether, or the acid anhydrides, salts or ester derivatives thereof. Further, they may contain alicyclic tetracarboxylic acid components in an amount of 10% by mole or less, preferably 5% by mole or less, in the aromatic tetracarboxylic acid components.

The polymerized polyimide precursors are used for producing polyimide precursor solutions by dissolving them in a ratio of 0.3 to 60 wt %, preferably 1 to 30 wt %, in the above-mentioned organic solvents (the polymerization solutions may be used as they are). The solvent viscosity of the produced polyimide precursors is 10 to 10,000 poise, preferably 40 to 3,000 poise.

The polyimide precursor solution, for example, is poured onto a smooth substrate in film-like shape, and thereafter, a solvent-substitution rate adjustment material is covered over at least one face thereof, to be a laminate membrane. The method for producing the laminate membrane by pouring the polyimide precursor solution is not particularly limited. Examples thereof may be a method of pouring the polyimide precursor solution onto a plate of such as glass to be a stand or onto a movable belt, and then covering the surface of the poured substance with a solvent substitution rate adjustment material; a method of applying the polyimide precursor solution to be a thin layer onto a solvent substitution rate adjustment material through spraying or doctor blade method; and a method of extruding the polyimide precursor solution out of a T-die, sandwiching the solution with the solvent substitution rate adjustment materials, and obtaining a three-layer membrane containing the solvent substitution rate adjustment materials in both face sides thereof.

The solvent substitution rate adjustment material may preferably be those having proper permeability wherein the solvent and a solidifying solvent of the polyimide precursor can permeate at a proper speed, upon precipitation of the polyimide precursor by contact of the laminate membrane with the solidifying solvent. The solvent substitution rate adjustment material may have a membrane thickness of 5 to 500 μm, preferably 10 to 100 μm. The material may have pores having a diameter of 0.01 to 10 μm, preferably 0.03 to 1 μm, which penetrate through the material in the direction of cross-section of the material, and which are dispersed at a sufficient density. If the membrane thickness of the solvent substitution rate adjustment material is thinner than the above-mentioned range, the solvent substitution rate becomes so fast as to form a dense layer on the surface of the polyimide precursor, as well as wrinkles are formed upon contact with the solidifying solvent in some cases, thus being improper. If it is thicker than the above-mentioned range, the solvent substitution rate becomes so slow as to make the porous structure to be formed in the inside of the polyimide precursor uneven.

As the solvent substitution rate adjustment material, practically nonwoven fabrics and porous membranes of polyolefins such as polyethylene and polypropylene; cellulose; and polyfluoroethylene resin may be used. In particular, in case of using a finely porous membrane made of a polyolefin, it gives excellent smoothness of the surface of a produced porous polyimide membrane.

The poured polyimide precursor membrane made to have a plural layer structure is brought into contact with the solidifying solvent through the solvent substitution rate adjustment material, so that the polyimide precursor is precipitated and made porous. Examples of the solidifying solvent for the polyimide precursor to be employed may include non-solvents to the polyimide precursor such as alcohols such as ethanol and methanol; acetone; and water; and solvent mixtures of these non-solvents of 50 to 99.5 wt % with the above-mentioned solvents for the polyimide precursor of 0.1 to 50 wt %. The combination of the non-solvents and the solvents is not particularly limited, but the solvent mixtures is preferable since the porous structure of the precipitated polyimide precursor becomes uniform by using the solvent mixtures of the non-solvents and any solvents are used as the solidifying solvent.

The polyimide precursor membrane made porous is then subjected to thermal or chemical treatment. The thermal treatment of the polyimide precursor membrane is carried out, after the solvent substitution rate adjustment material is removed from the membrane, by fixing the polyimide precursor porous membrane through pins, chucks or pinch rolls in such a manner that no thermal shrinkage is caused, and by heating the porous membrane at 280 to 500° C. for 5 to 60 minutes under the atmospheric air.

The chemical treatment of the polyimide precursor porous membrane is carried out using a fatty acid anhydride or an aromatic acid anhydride as a dehydration agent and a tertiary amine such as triethylamine as a catalyst. Also, as described in Japanese Patent Application Laid-Open (JP-A) No. 4-339835, imidazole, benzimidazole, or their substitution derivatives may be used for the treatment.

The chemical treatment of the polyimide precursor porous membrane is employed preferably in the case the porous polyimide membrane is formed to have a plural layer structure. The plural-layered porous polyimide membrane can be produced by carrying out plasma, electron beam, or chemical treatment of the surface of polyolefin finely porous membrane to be used as the solvent substitution rate adjustment material, in order to improve interface adhesion with the porous polyimide membrane, forming a plurality of layers with the poured polyimide precursor solution-derived substance, bringing the resulting body with the solidifying solvent for precipitating the poured polyimide precursor-derived substance to make the resulting membrane porous, and then successively carrying out chemical treatment. The chemical treatment of the porous polyimide membrane having a plurality of layers is preferably carried out in a temperature range not higher than a melting point or a heat resistant temperature of the solvent substitution rate adjustment material.

The imidation ratio of the porous polyimide membrane subjected to the thermal or chemical treatment is 50% or higher, preferably.70 to 99%.

The imidation ratio is calculated by at first computing the absorbance ratio of the characteristic absorbance of light with wavelength of 740 cm⁻¹ or 1,780 cm⁻¹ by imide group to the absorbance of light with wavelength of 1,510 cm⁻¹ by phenyl group as an internal standard and calculating the ratio on the basis of the percentage (%) of the computed absorbance ratio to that calculated separately in the case of a polyimide membrane with 100% imidation ratio, by a method using IR absorption spectroscopy (ATR method).

The porous polyimide membrane produced in such a manner has a porosity 20 to 80%, preferably 40 to 70% and an average pore diameter of 0.01 to 1 μm, preferably 0.05 to 1 μm, depending on the selection of the production conditions. The porous polyimide membrane may be a monolayered or a plural-layered one, and the thickness of the membrane as a whole may be adjusted to be 5 to 300 μm. The heat resistance temperature of the polyimide porous layer may be 200° C. or higher. Also, the thermal shrinkage may be ±1% upon heating at 105° C. for 8 hours. The heat resistance temperature of the polyimide porous layer to be used preferably may be sufficient to be 200° C. or higher and its upper limit is not particularly limited, but in general, it is about 500° C. or lower. As used herein, the heat resistance temperature means the glass transition temperature (Tg) evaluated, for example, by DSC.

The porous polyimide membrane to be used for the present invention may include porous membranes made of polyimides, as well as composite materials with inorganic materials such as glass, alumina or silica, or other organic materials. In case of using such composite materials, the membrane may have a layered structure comprising two or more layers.

The porous membrane to be used for the present invention may be properly a porous polyimide membrane in terms of the solvent-insolubility, softness and/or flexibility, and easiness to be thin. In particular, it is preferable for the polyimide to be those respectively comprising 3,3′,4,4′-biphenyltetracarboxylic acid dianhydride as a tetracarboxylic acid component and oxydianiline as a diamine component, especially those respectively containing 3,3′,4,4′-biphenyltetracarboxylic acid dianhydride as a main tetracarboxylic acid component and oxydianiline as a main diamine component, in terms of the size stability, rigidity, toughness, and chemical stability of the porous membrane and an electrolyte membrane to be obtained.

Further, in the case the electrolyte membrane obtained by the invention is to be used for the electrolyte membrane for direct methanol fuel cell, the porous membrane may be a material which is not substantially swollen with methanol or water.

A polyimide type porous membrane can be obtained by polymerizing a tetracarboxylic acid component, e.g., an aromatic tetracarboxylic acid component such as 3,3,′4,4′-biphenyltetracarboxylic acid dianhydride or pyromellitic acid dianhydride, with an aromatic diamine component, e.g., oxydianiline, diaminodiphenylmethane or p-phenylenediamine in an organic solvent such as N-methyl-2-pyrrolidone, N,N-dimethylacetamide or N,N-dimethylformamide for obtaining a polyamic acid solution and then carrying out porous membrane formation by, for example, pouring the polyamic acid solution on a flat substrate, bringing the poured solution into contact with a solvent substitution rate adjustment material made of a porous polyolefin, immersing in a solidifying solution such as water for obtaining a porous membrane of a polyimide precursor, and then heating the porous membrane of the polyimide precursor at 280 to 500° C. for 5 to 60 minutes in atmospheric air while fixing both ends of the membrane.

The porous membrane may be those having channels (penetrating pores) in which a gas or a liquid (e.g., an alcohol) can pass through both faces of the membrane and having a porosity of 20 to 80%.

The porous membrane is preferable to have an average diameter of pores in a range of 0.01 to 1 μm, more preferably 0.05 to 1 μm.

Further, the membrane thickness of the porous membrane is preferably 1 to 300 μm (for example 5 to 300 μm), more preferably 5 to 100 μm, and even more preferably 5 to 50 μm. The porosity, the average diameter of the fine pores, and the membrane thickness of the porous membrane may be planed on the basis of the strength of the membrane to be obtained, the characteristics in case of using the membrane, for example, the characteristics in case of using the membrane as an electrolyte membrane.

A polyamide porous membrane to be used for the present invention can be obtained by treating a composition consisting of polyamide and polyester with an organic solvent.

Polyamides to be used for the present invention may include polymers and copolymers obtained from ε-caprolactam, 6-aminocapric acid, ω-enantholactam, 7-aminoheptanoic acid, 11-aminoundecanoic acid, 9-aminononanoic acid, α-pyrrolidone, α-piperidone or the like.

Also, the polyamides may include nylon 6 produced by ring-opening polymerization of ε-caprolactam; nylon 66 produced by condensation polymerization of hexamethylenediamine and, sebacic acid; nylon 610 produced by condensation polymerization of hexamethylenediamine and sebacic acid; nylon 12 produced by ring-opening polymerization of ω-laurolactam or from 12-aminododecanoic acid; and copolymerized nylons having two or more components selected from the foregoing examples.

Further, the polyamides may include nylon MXD 6, which is a crystalline thermoplastic polymer obtained by m-xylenediamine (MXDA) and adipic acid; nylon 46 produced from 1,4-butanediamine and adipic acid; methoxymethylated polyamides obtained by substituting hydrogen atoms of amido bonds of nylon resins with methoxymethyl groups; and further aromatic polyamides obtained by terephthalic acid and p-phenylenediamine.

These polyamides are strong and tough as compared with other thermoplastic plastics, and have a low friction resistance coefficient. They are light and have high tensile strength as compared with metals. They are excellent in formability and mass productivity. They have high melting points and a wide range of usable temperature up to ±100° C. and are excellent in heat- and cold-resistance. As compared with metallic materials, they have a small elasticity coefficient and absorb impacts and vibrations. They are especially excellent in oil proofness and alkali proofness.

The molecular weight of the polyamides is not particularly limited, but the average molecular weight may be preferably 8,000 to 50,000, more preferably 10,000 to 30,000.

Examples of the polyesters may include common polyesters and polylactones obtained by ring-opening polymerization of lactone. Examples of polylactones may be those obtained by ring-opening polymerization of cyclic esters such as propiolactone(β-lactone), butyrolactone(γ-lactone), δ-valerolactone(δ-lactone) and the like. The molecular weight of the polyesters is not particularly limited, but the average molecular weight may be preferably 1,000 to 50,000, more preferably 1,500 to 20,000.

The mixing ratio of the polyamides and the polyesters is not particularly limited, but it may be preferably as nylon:polyester (25 to 75):(75 to25) (% by weight), more preferably (30 to 70):(70 to 30) (% by weight). If the ratio is out of the above-mentioned range, the dispersion state of compositions containing nylon and polyesters is deteriorated and there occurs a problem that it becomes difficult to form through pores penetrating through the nylon-porous membranes produced from the compositions.

As a mixing method of the compositions of polyamides and polyesters, common methods such as wet methods, e.g. casting methods, can be employed. The casting methods may include, for example, a method forming membranes by preparing and casting the solution mixtures having polyamides and polyester.

Solvents for the above-mentioned solution mixtures may include hexafluoroisopropanol, trifluoroethanol, acetic acid, m-cresol, formic acid, sulfuric acid, chlorophenol, trichloroacetic acid, ethylene carbonate, phosphoric acid, hexamethylphosphoric acid triamide.

The concentration of solutions to be cast is generally 20 to 50% by weight. The temperature for casting is generally a room temperature in case of using hexafluoroisopropanol, and it may be a high temperature depending on conditions. Compositions can be produced by applying the solutions to be cast to glass or the like and drying the solutions preferably at a room temperature. At the time of drying, the solutions may be left while being kept upside down.

Mixing may be carried out in a dry manner such as melt kneading using a common kneader. The kneader may be a single extruder, a twin extruder, a mixing roll, a Banbury mixer and the like. The compositions may be melted and kneaded to obtain in form of pellets. The pellets may be formed into any shapes such as formed products, films, pipes, and tubes by injection molding, blow molding or extrusion molding.

The porosity of the porous substrates of the present invention obtained in such a manner may be 20 to 80%, preferably 30 to 70%.

The average pore diameter may be in a range of 0.01 to 1 μm, preferably 0.05 to 1 μm.

The thickness of the substrates may be 300 μm or thinner, preferably 5 to 300 μm.

It is preferable for the porous substrates of the present invention to have no or reduced change in surface area at the time of wetting or drying. In this regard, the porous substrates of the present invention may have a heat resistant temperature of 200° C. or higher and a thermal shrinkage of ±1% or less, upon heating at 105° C. for 8 hours. Further, the porous substrates of the present invention may have network structures comprised of polymer phases and void phases, to form fine continuous pores, and may have porous structures in both surfaces.

An electrolyte membrane of the present invention is obtained by filling the surface of a substrate of a porous material, in particular, the inner surface of the fine pores, with a first polymer. The method for filling with the first polymer may be a conventionally known method for filling. The method may be one such that one end of the first polymer is bound to the inner surface of the pores. Further, a third polymer, which may be same as or different from the first polymer, may be filled other than the first polymer.

The first polymer is preferable to have ion exchange groups. As used herein, the “ion exchange groups” mean groups retaining protons such as —SO₃⁻ derived from —SO₃H and easy to release them. They exist like pendants in the first polymer, and proton conductivity is generated by filling the fine pores with the polymer. Accordingly, the first polymer is preferably derived from a first monomer having an ion exchange group.

Examples of the method for forming bonding of one end of the first polymer to the inner surface of the pores are as follows. For example, a substrate is excited by plasma, UV rays, electron beam, or γ-ray to form reaction starting points in at least the inner surface of pores of the substrate and the first monomer is brought into contact with the reaction starting points to bond the first polymer. Also, a chemical method using a silane coupler and the like may be employed for bonding the first polymer to the inner surface of the fine pores. Further, after using a general polymerization method in which the first polymer is obtained by filling the pores with the first monomer and then carrying out polymerization reaction of the first monomer in the inside of the pores, a coupling agent including the above-mentioned silane coupler may be used to chemically bond the first polymer to the substrate.

In the present invention, if the first polymer, wherein one end thereof is bound to the surface of the pores, is filled into the pores, a plasma graft polymerization method may preferably be employed. The plasma graft polymerization can be carried out by a liquid phase method or a well-known vapor phase polymerization method. For example, the plasma graft polymerization method is carried out as follow: producing reaction starting points in the substrate surface as well as the inner surface of the pores after the substrate is irradiated by plasma, and then carrying out graft polymerization of the first monomer, which will form the first polymer, in the substrate surface and inside of the fine pores by bringing the first monomer into contact with the starting points by a known liquid phase polymerization method. More detailed contents of the plasma graft polymerization method are described in precedent patent applications applied by some of the inventors of the invention; JP-A Nos. 3-98632, 4-334531, 5-31343, 5-237352, 6-246141, and WO 00/54351 (these documents are entirely incorporated herein as references).

Monomers which can be used as the first monomer of the present invention may preferably be those which can provide polymer substances having proton conductivity.

Examples of such monomers may be:
(1) monomers such as anionic unsaturated monomers and their salts comprising vinyl groups, strongly acidic groups such as sulfonic acid and phosphonic acid, and weakly acidic groups such as carboxyl; and also their derivatives such as esters and monomers; and examples of such monomers are sodium p-styrenesulfonate, sulfonic acid or the derivatives of acrylamide or phosphonic acid or the derivatives of acrylamide, 2-(meth)acrylamido-2-methylpropanesulfonic acid, 2-(meth)acryloylethanesulfonic acid, 2-(meth)acryloylpropanesulfonic acid, (meth)allylsulfonic acid, (meth)allylphosphonic acid, vinylsulfonic acid, vinylphosphonic acid, styrenesulfonic acid, styrenephosphonic acid, (meth)acrylic acid, maleic acid(anhydride), fumaric acid, crotonic acid, itaconic acid and the like;
(2) monomers having vinyl groups, strongly basic groups such as amines, and weakly acidic groups; and also their derivatives such as esters and polymers; and examples of such monomers are amino-containing unsaturated monomers and their quaternary compounds such as allylamine, ethyleneimine, N,N-dimethylaminoethyl(meth)acrylate, N,N-dimethylaminopropyl(meth)acrylamide and the like; and
(3) nonionic unsaturated monomers such as (meth)acrylamide, N-substituted (meth)acrylate, 2-hydroxyethyl(meth)acrylate, 2-hydroxypropyl(meth)acrylate, methoxypolyethyleneglycol(meth)acrylate, and polyethyleneglycol(meth)acrylate; and also their derivatives and their polymers.

Among them, the compounds (1) have proton conductivity. Compounds (2) and (3) may be used as auxiliary materials of the compounds (1) or can be provided with doping with a strong acid after polymerization.

Only one type of monomers among these monomers may be used for producing homopolymers, or two or more of them may be used for producing copolymers. In case a salt type such as sodium salt is used as an electrolytic substance, it is preferable to produce polymers and then converting them to be proton type.

In case of copolymers, the above-mentioned polymers or monomers may be copolymerized with other types of monomers. As other types of monomers to be copolymerized may be methyl(meth)acrylate, methylene bisacrylamide and the like.

As used herein, the term “(meth)acryl” means acryl and/or methacryl; the term “(meth)acryloyl” means acryloyl and/or methacryloyl; the term “(meth)allyl” means allyl and/or methallyl; and the term “(meth)acrylate” means “acrylate and/or methacrylate”.

One or more types of these unsaturated monomers may be selected for use and in consideration of the proton conductivity of the polymers after polymerization, it is preferable to use unsaturated monomers containing sulfonic acid group as indispensable components. Among the unsaturated monomers containing sulfonic acid group, 2-(meth)acrylamido-2-methylpropanesulfonic acid is particularly preferable since it is highly polymerizable and suitable for producing polymers with a high acid value and a little quantity of remaining monomer as compared with the case of using other monomers.

The above-mentioned proton conductive polymers in the invention may have a cross-linked structure, and therefore they may be substantially dissolved in methanol and water. The method of introducing the cross-linked structure into the polymer may be suitably carried out by polymerization by heating. Practically, a method of polymerization reaction by heating at 40 to 240° C. for 1 to 30 hours may be used. Upon polymerization, a cross-linking agent (a reaction initiator) having two or more groups reactive on functional groups of the polymer may be used.

Examples of the cross-linking agent may include N,N-methylenebis(meth)acrylamide, polyethylene glycol di(meth)acrylate, polypropylene glycol di(meth)acrylate, trimethylol propanediallyl ether, pentaerythritol triallyl ether, divinylbenzene, bisphenol di(meth)acrylate, isocyanuric acid (meth)acrylate, tetraallyloxyethane, triallylamine, diallyloxy acetic acid salt and the like. These cross-linking agents may be used alone or two or more of them may be used in combination, if necessary.

The amount used of the above-mentioned copolymerizable cross-linking agents may be preferably 0.01 to 40% by weight, further preferably 0.1 to 30% by weight, even more preferably 1 to 20% by weight. If the amount of the cross-linking agent is too small, the uncross-linked polymers are easy to be eluted. Further, if it is too much, the cross-linking components are hardly compatible. Therefore, both cases are not preferable.

The proton conductivity of the electrolyte membrane is changed depending on the types of the first and/or the third monomer to be use, which will be described later. Accordingly, it is preferable to use monomer materials with high proton conductivity. Further, the proton conductivity of the electrolytic substance depends on the polymerization degree of the polymer filled in the pores.

In case of using the third polymer, the third polymer may be same as or different from the first polymer. That is, as a third monomer to be the third polymer, one or two types of the polymers and the monomers exemplified for the first polymer and the third monomer may be selected. Preferable examples of the third monomer are those exemplified for the above-mentioned third monomers and vinylsulfonic acid in addition to them. In the case, one kind of monomer is selected as the third monomer, the third polymer is a homopolymer, and in the case two or more kinds of monomers are selected as the third monomer, the third polymer may be copolymers.

In the case of using the third polymer, the third polymer may be preferably chemically and/or physically bonded to the first polymer. For example, the third polymer may entirely chemically be bonded to the first polymer, or the third polymer may entirely physically be bonded to the first polymer. Further, a portion of the third polymer may chemically be bonded to the first polymer and the rest of the third polymer may physically be bonded to the first polymer. Furthermore, the chemical bond may include bonding of the first polymer and the third polymer. The bond can be formed by making the first polymer carrying reactive groups and causing reaction of the reactive groups with the third polymer and/or the third monomer. The physical bonding state may be the state that the first and the third polymers are entangles with each other.

Use of the third polymer makes it possible to suppress permeation (cross-over) of methanol, prevent elution or leakage of the entire polymer filled in the pores out of the pores, and improve the proton conductivity. In particular, chemical bonding and/or physical bonding of the first polymer and the third polymer makes it possible to prevent the elution or leakage of the entire polymer filled in the pores out of the pores. Even in the case the polymerization degree of the first polymer is low, existence of the third polymer, especially the third polymer having a high polymerization degree increases the proton conductivity of the electrolyte membrane to be obtained.

The electrolyte membrane of the present invention may be preferably used for a fuel cell, particularly a direct methanol solid polymer fuel cell or are forming type methanol solid polymer fuel cell. The electrolyte membrane of the present invention is particularly preferable to be used for the direct methanol solid polymer fuel cell.

In a preferable aspect of the present invention, following embodiments are provided.

1) A method comprising a step of repeating the polymerization of a monomer followed by filling the pores with the monomer and heating the monomer at least once, after the polymerization step by heating.

2) A method according to claim 1, comprising polymerization by heating combined with one step selected from the following (X-1) to (X-4) steps, or combinations of two steps, or three, or all of these steps, thereafter the step of filling the pores of the porous membrane with the electrolytic substance; and/or after the step of filling the pores of the porous membrane with electrolytic substance, and the following (Y-1) step and/or (Y-2) step:
(X-1) a step of making the porous membrane hydrophilic and immersing the porous membrane in a monomer or its solution;
(X-2) a step of adding a surfactant to a monomer or its solution to produce an immersion solution and immersing the porous membrane in the immersion solution;
(X-3) a step of reducing pressure in the state that the porous membrane is immersed in the monomer or its solution;
(X-4) a step of radiating ultrasonic wave in the state that the porous membrane is immersed in the monomer or its solution; and
(Y-1) a step of bringing a porous substrate for absorbing the electrolytic substance into contact with both surfaces of the porous membrane; and
(Y-2) a step of removing the electrolytic substance adhering to both surfaces of the porous membrane by a smooth material.

In the above-mentioned method, one of the steps among the X-step group consisting of (X-1) to (X-4) and Y-step group consisting of (Y-1) and (Y-2) is included. Furthermore, the method of the present invention may include two or more of the steps.

The any two or more of the steps may be selected from only the X-step group or the Y-step group and both of the X-step group and the Y-step group.

In the case of selecting two or more steps from the X-step, it is preferable to carry out these steps in the order of the steps of smaller numbers. That is, in the case of carrying out (X-1) and (X-2), it is preferable to carry out at first (X-1) step and then (X-2) step. Furthermore, (X-3) step and (X-4) step may be carried out simultaneously.

In the case of carrying out both (Y-1) step and (Y-2) step, the order is optional. Furthermore, in the case the porous substrate in (Y-1) step is the smooth material in (Y-2) step, both (Y-1) step and (Y-2) step may be carried out simultaneously.

An electrolyte membrane obtained by a method of the present invention having any one of steps among the X-step group and the Y-step group can provide an improved ability of the filling ratio of an electrolytic substance and/or the improved function and an improved effect of the shape retention property for the electrolyte membrane (e.g., suppressing curling).

The monomer producing the proton conductive polymer for an electrolytic substance filled in the pores according to the present invention is subjected to a step of thermal polymerization after the monomer is filled in the pores. The polymerization step may be after the filling of the monomer as the electrolytic substance and either before or after the above-mentioned Y-step group. Preferably, the polymerization step may be before the Y-step group. Also, it is preferable to comprise a step of filling the fine pores with a radical polymerization initiator as the electrolytic substance or in addition to the electrolytic substance, together with the monomer that is the electrolytic substrate, for using upon the polymerization. The step of filling the pores with the radical polymerization initiator may be carried out simultaneously with the step of filling the fine pores with the electrolytic substance.

The step (X-1) of making the porous membrane, for example, a porous polymer membrane, hydrophilic is preferably carried out by vacuum plasma discharge treatment for the polymer porous membrane under oxygen atmosphere. Although in the plasma discharge treatment, active points can be produced in the pores of the porous polymer membrane by plasma discharge treatment under argon gas atmosphere, they disappear in a short time (in several seconds) and no hydrophilization can be achieved. However, the hydrophilization effect by the above-mentioned method is maintained for long duration (even after, for example, 1 to 2 weeks).

The optimum conditions for the above-mentioned vacuum plasma discharge treatment under the oxygen atmosphere can be selected depending on the thickness, the chemical structure, and the porous structure of the object porous membrane to be treated. For example, in the case of a polyimide type porous membrane having a thickness of 30 μm and synthesized by reaction of 3,3′4,4′-biphenyltetracarboxylic acid dianhydride (s-BPDA) and oxydianiline (ODA), the treatment may be preferably carried out in the conditions of 0.01 to 0.5 Pa and 0.05 to 10 W/cm² for 60 to 6,000 seconds, in the presence of air.

Furthermore, in the case of combining the hydrophilization step (X-1) with other steps of the X-step group, the hydrophilization step (X-1) is preferably carried out at first.

As a method of filling the pores with the electrolytic substance according to the present invention, for example, the porous membrane may be immersed in the above-mentioned monomer or its solution, preferably in an aqueous monomer solution. The aqueous solution may contain a hydrophilic organic solvent.

In such a state, a surfactant may be preferably added to the aqueous monomer solution. Use of the surfactant in combination makes it possible to fill even the inside of the pores with the aqueous monomer solution even if the aqueous monomer solution is difficult to enter into the inside of the pores in a normal case owing to inferior wettability. The monomer is polymerized to give a desired electrolyte membrane, for example, the above-mentioned electrolyte membrane. Examples of such a surfactant are as follows.

Examples of anionic surfactants may be fatty acid salts such as mixed fatty acid sodium salt soap, semi-cured tallow oil-derived fatty acid sodium salt soap, sodium stearate soap, potassium oleate soap and castor oil potassium soap; alkyl sulfate ester salt such as sodium lauryl sulfate, sodium higher alcohol sulfate and triethanolammine lauryl sulfate; alkylbenzenesulfonate salts such as sodium dodecylbenzenesulfonate; alkylnaphthalenesulfonate salts such as sodium alkylnaphthalenesulfonate; alkylsulfosuccinate salts such as sodium dialkylsulfosuccinate; alkyldiphenyl ether disulfonate salts such as sodium alkyldiphenyl ether disulfonate; alkyl phosphate salts such as potassium alkylphosphate; polyoxyethylene alkyl (or alkylallyl) sulfate ester salts such as sodium polyoxyethylene lauryl ether sulfate, sodium polyoxyethylene alkyl ether sulfate, triethanolammine polyoxyethylene alkyl ether sulfate and sodium polyoxyethylene alkylphenyl ether sulfate; special reaction type anionic surfactants; special carboxylic acid type surfactants; naphthalenesulfonic acid formalin condensates such as sodium salt of β-naphthalenesulfonic acid formalin condensate and sodium salt of special aromatic sulfonic acid formalin condensate; special polycarboxylic acid type polymer surfactants; and polyoxyethylene alkyl phosphates.

Examples of nonionic surfactants may include polyoxyethylene alkyl ethers such as polyoxyethylene lauryl ether, polyoxyethylene cetyl ether, polyoxyethylene stearyl ether, polyoxyethylene oleyl ether and polyoxyethylene higher alcohol ether; polyoxyethylene alkyl aryl ethers such as polyoxyethylene nonyl phenyl ether; polyoxyethylene derivatives; sorbitan fatty acid esters such as sorbitan monolaurate, sorbitan monopalmitate, sorbitan monostearate, sorbitan tristearate, sorbitan monooleate, sorbitan trioleate, sorbitan sesquioleate and sorbitan distearate; polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate and polyoxyethylene sorbitan trioleate; polyoxyethylene sorbitol fatty acid esters such as polyoxyethylene sorbitol tetraoleate; glycerin fatty acid esters such as glycerol monostearate, glycerol monooleate, self-emulsifying type glycerol monostearate; polyoxyethylene fatty acid esters such as polyethylene glycol monolaurate, polyethylene glycol monostearate, polyethylene glycol distearate and polyethylene glycol monooleate; polyoxyethylenealkylamines; polyoxyethylene-cured castor oil; alkylalkanolamides; and the like.

Examples of cationic surfactants and amphoteric surfactants may include alkylamine salts such as coconut amine acetate and stearylamine acetate; quaternary ammonium salts such as lauryltrimethylammonium chloride, stearyltrimethylammonium chloride, cetyltrimethylammonium chloride, distearyldimethylammonium chloride, alkylbenzyldimethylammonium chloride; alkylbetaine such as laurylbetaine, stearylbetaine and laurylcarboxymethylhydroxyethylimidazolinium betaine; and amine oxides such as lauryldimethylamine oxide.

Further, the surfactant may include fluoro type surfactants. Preferably, use of a fluoro type surfactant can improve the wettability of an aqueous monomer solution even if the amount is small and therefore the effect of the surfactant as an impurity is slight. There are a variety of types of fluoro type surfactants to be used in the present invention. Examples may include those having fluorocarbons as skeleton structures such as perfluoroalkyl groups or perfluoroalkenyl groups obtained by substituting hydrogen of the hydrophobic groups in general surfactants with fluorine and having remarkably improved surface activation capability. If the hydrophilic groups of the fluoro type surfactants are changed, four types; anionic, nonionic, cationic and amphoteric; of surfactants can be obtained. Typical examples of the fluoro type surfactants are as follows.

Examples may include fluoroalkyl (C2-C10) carboxylic acids, disodium N-perfluorooctanesulfonylglutamate, sodium 3-[fluoroalkyl(C6-C11)oxy]-1-alkyl(C3-C4)sulfonate, sodium 3-[ω-fluoroalkanoyl(C6-C8)-N-ethylamino]-1-propanesulfonate, N-[3-(perfluorooctanesulfonamido)propyl]-N,N-dimethyl-N-carboxymethyleneammoniumbetaine, fluoroalkyl(C11-C20)carboxylic acid, perfluoroalkylcarboxylic acid (C7-C13), perfluorooctanesulfonic acid diethanolamide, perfluoroalkyl(C4-C12)sulfonate salts (Li, K and Na), N-propyl-N-(2-hydroxyethyl)perfluorooctanesulfonamide, perfluoroalkyl(C6-C10)sulfoneamidopropyltrimethylammonium salts, perfluoroalkyl(C6-C10)-N-ethylsulfonylglycine salts (K), bis(N-perfluorooctylsulfonyl-N-ethylaminoethyl)phosphate, monoperfluoroalkyl(C6-C16)ethyl phosphates, perfluoroalkenyl quaternary ammonium salts, perfluoroalkenyl polyoxyethylene ethers, sodium perfluoroalkenylsulfonates, and the like.

Further, the surfactant may include silicone type surfactants. Use of a silicone type surfactant can improve the wettability of an aqueous monomer solution even if the amount is small. There are a variety of types of silicone type surfactants to be used in the present invention. Examples may include those obtained by modifying silicones with polyethylene oxide or polypropylene oxide to make them hydrophilic.

The amount used of these surfactants depends on the coexisting electrolytic substance, the porous membrane to be used, and the properties and characteristics of the desired electrolyte membrane. For example, if the electrolytic substance is an unsaturated monomer, the amount of the surfactant is preferably.0.001 to 5% by weight, more preferably 0.01 to 5% by weight, and even more preferably 0.01 to 1% by weight based on the total amount of the unsaturated monomer. If the amount is too small, the porous substrate cannot be filled sufficiently with the monomer. If it is too much, not only the effect is insignificant to result in vain consumption of the surfactants but also they remain as impurities in the membrane to result in deterioration of properties of the electrolyte membrane to be obtained, e.g., the electrolytic substance of a fuel cell.

The concentration of the aqueous monomer solution to be used in the present invention is not particularly limited, if the monomer, the surfactant, and a polymerization initiator to be added if necessary, and other additives are dissolved therein. The concentration may be preferably 5% by weight or higher, more preferably 10% by weight or higher, and even more preferably 20% by weight or higher in terms of polymerization reaction proceeding.

The method of the present invention may preferably comprise reducing the pressure, preferably to 10⁴ to 10⁻⁵ Pa for 10 to 300,000 seconds while the porous membrane being immersed in the electrolytic substance or its solution, thereby filling the pores of the porous membrane with the electrolytic substance, for example the above-mentioned monomer. Further, the method may comprise a step of polymerizing and/or heating the monomer to have a high molecular weight by UV radiation, if necessary, in the presence of a reaction initiator, and then drying in vacuo (either one step may be repeated, if necessary), to obtain the electrolyte membrane.

In the method of the present invention, it is preferable to radiate ultrasonic wave in the state that the porous membrane is immersed in the electrolytic substance or its solution. Ultrasonic wave radiation promotes the filling of the pores with the electrolytic substance solution, for example the aqueous monomer solution, in a short time. Further, ultrasonic wave radiation is effective to degas the electrolytic substance solution, for example the aqueous monomer solution, to reduce the inhibition of polymerization because of dissolved oxygen in the aqueous solution. Further, it is effective to prevent formation of pinholes which are formed in the membrane in the case foams are generated at the time of polymerization or insufficient filling of the pores with the monomer and thus the electrolyte membrane to be obtained can be prevented from deterioration in the properties.

As a method of filling the pores of the porous membrane with the electrolytic substance, it is preferable to immerse the porous membrane in the above-mentioned monomer as the electrolytic substance or its solution, preferably the aqueous monomer solution.

The monomer solution contains the monomer; a radical reaction initiator; an organic solvent, particularly a hydrophilic organic solvent such as ethanol, methanol, isopropanol, dimethylformamide, N-methyl-2-pyrrolidone or dimethylacetamide; and water. A preferable example may be a solution mixture having a monomer concentration of 1 to 75% by weight and a water content of 25 to 99% by weight.

The monomer filled in the pores of the porous membrane may be thermally polymerized, to produce a desired polymer, for example a proton conductive polymer in the pores.

A known technique of an aqueous solution radical polymerization method may be employed, as the method for thermal polymerization of the monomer in the pores according to the present invention. Examples of the method may be heat initiation polymerization.

Radical polymerization initiators for the heat initiation polymerization may include the following substances: azo compounds such as 2,2′-azobis (2-amidinopropane)dihydrochloric acid salt; and peroxides such as ammonium persulfate, potassium persulfate, sodium persulfate, hydrogen peroxide, benzoyl peroxide, cumene hydroperoxide, di-tert-butyl peroxide; azo-type radical polymerization initiators such as 2,2′-azobis(2-amidinopropane) dihydrochloride and azobis(cyanoevaleric acid). These radical polymerization initiators may be used alone or two or more of them may be used in combination.

In an aspect of the present invention, as described above, the proton conductive polymer produced from the monomer, which is the electrolytic substance filled in the porous membrane, may be preferably chemically bonded to the interface of the porous membrane. The method for forming the chemical bonding may include, as described above, a method for generating radical in the porous membrane surface by radiating electron beam, UV rays or plasma before filling with the monomer, and a method of using a hydrogen abstraction type radical polymerization initiator, which will be described later. It is preferable to use the hydrogen abstraction type radical polymerization initiator since the steps are simpler.

In the method of the present invention, after the pores of the porous membrane are filled with the electrolytic substance, it is preferable to carry out the Y-1 step of bringing a porous substrate absorbing the electrolytic substance into contact with both surfaces of the porous membrane. The porous substrate may include paper for wrapping powdered medicine, nonwoven fabrics, filtration paper, Japanese paper and the like.

In the present invention, it is preferable to carry out the Y-2 step of removing the excess electrolytic substance adhering to both surfaces of the polymer porous membrane by a smooth material such as glass, a non-corrosive metal (e.g. a stainless steel), a plate made of a plastic, or a spatula after the pores of the porous membrane, for example a polymer porous membrane, are filled with the electrolytic substance.

The Y-2 step may be carried out in place of the above-mentioned Y-1 step, or before or after the Y-1 step in combination with the Y-1 step.

The method for producing the electrolyte membrane according to the present invention can provide a functional material comprising, for example, a porous polyimide membrane as a substrate, which retains a substance having a proton conductive function, and excellent in evenness and smoothness.

Since having the above-mentioned properties, the electrolyte membrane obtained by the method according to the present is advantageously usable for an electrolyte membrane or a fuel cell. In particular, the electrolyte membrane may be preferably used for a fuel cell, especially direct methanol solid polymer fuel cell. The direct methanol solid polymer fuel cell comprises a cathode, an anode, and an electrolyte sandwiched therebetween and the electrolyte membrane of the present invention may be used as the electrolytic substance.

The electrolyte membrane obtained by the method according to the present can advantageously be used for the electrolyte membrane for the fuel cell.

The electrolyte membrane for the fuel cell of the present invention may have a proton conductivity of 0.001 S/cm or more and 10.0 S/cm or less, preferably 0.01 S/cm or more and 10.0 S/cm or less at 25° C. in 100% humidity; a reciprocal number of methanol permeability of 0.01 m² h/kgμm or more and 10.0 m² h/kgμm or less, preferably 0. 01 m² h/kgμm ore more and 1.0 m² h/kgμm or less at 25° C.; and a ratio of change in surface area between dry and wet states of 1% or less at 25° C.

If the proton conductivity, the reciprocal number of methanol permeability, and the ratio of change in surface area between dry and wet states are out of the above-mentioned ranges, respectively, the electrolyte membrane is not suitable for the electrolyte membrane for the fuel cell and it is difficult to produce the membrane by the above-mentioned production method.

With respect to the ratio of change in surface area of the electrolyte membrane for the fuel cell, if its value is high, it causes damages in the interface between the membrane and electrodes, and thus the ratio considerably affects the cell properties such as turning on-off stability and durability. Therefore, the ratio is preferably within the above-mentioned range.

As described above, the electrolyte membrane of the present invention is advantageously useful for the fuel cell. In particular, the electrolyte membrane is preferable to be used for the fuel cell, especially the direct methanol solid polymer fuel cell. The fuel cell comprises, as constituent components, an anode and a cathode each comprising catalyst layers and the electrolyte membrane sandwiched between both electrodes. The electrolyte membrane-electrode assembly becomes a proton conductor when the above-mentioned solid polymer electrolyte membrane is filled with water.

A methanol fuel cell also has a structure similar to that described above. The methanol fuel cell may be a reforming type methanol fuel cell comprising a reformer in anode side.

The cathode may have a conventionally known configuration and comprises a catalyst layer and a support layer for supporting the catalyst in this order from the electrolyte side.

Also, the anode may have a conventionally known configuration and comprises a catalyst layer and a support layer for supporting the catalyst in this order from the electrolyte side.

The electrolyte membrane-electrode assembly comprising the electrolyte membrane of the present invention as one constituent component can be obtained by forming catalyst layers having a noble metal in both faces of the above-mentioned electrolyte membrane.

The noble metal may include one metal selected from palladium, platinum, rhodium, ruthenium and iridium; their alloys; combinations of them; and combinations of them with other transition metals.

Carbon fine particles of such as carbon black carrying particles of the above-mentioned noble metal may be used as the catalyst.

The carbon fine particles carrying the noble metal fine particles may preferably contain 10 to 60% by weight of the noble metal.

A method of carrying the electrode catalyst on the conductive material may be a method of immersing the conductive material in an aqueous solution containing colloidal particles of such as oxide or complex oxide of the metal for the electrode catalyst component or an aqueous solution containing a salt such as chloride, nitrate, or sulfate of the metal for the electrode catalyst component; and thereby depositing the metal component on the conductive material. After the deposition, if necessary, reduction treatment may be carried out by using a reducing agent such as hydrogen, formaldehyde, hydrazine, formic acid salts, sodium boron hydride. Further, if the hydrophilic functional group of the conductive material is an acidic group such as sulfonic acid group, the conductive material is immersed in an aqueous solution of the above-mentioned metal salt, to take the metal component into the conductive material by ion exchange, and then the reduction treatment using the above-mentioned reducing agent may be carried out.

It is also preferable to use a polymer electrolyte and/or an oligomer electrolyte (ionomer) in combination with the carbon fine particles carrying the noble metal fine particles.

A paste for forming the catalyst layer, which is obtained by evenly dispersing the carbon fine particles carrying the noble metal fine particles, and, if necessary, the polymer electrolyte or oligomer electrolyte (ionomer) in a solvent, can be used to form the catalyst layers in the entire surfaces or in predetermined shaped in both faces of the electrolyte membrane, to obtain the electrolyte membrane-electrode assembly.

The above-mentioned polymer electrolyte or oligomer electrolyte may include any polymers or oligomers having ion conductivity, or any polymers or oligomers from which can generate polymers or oligomers having ion conductivity through the reaction with an acid or a base.

Preferable polymer electrolytes or oligomer electrolytes may include fluoro polymers having a proton or pendant ion exchange groups in form of salts such as sulfonic acid, for example sulfonic acid fluoro polymers such as Nafion (registered trademark of Du Pont), sulfonic acid fluoro oligomers, sulfonated polyimides, sulfonated oligomers and the like.

The above-mentioned polymer electrolytes or oligomer electrolytes are required to be practically water-insoluble at a temperature of 100° C. or lower.

The paste for catalyst layer formation may be those obtained by mixing the catalyst particles with a liquid state polymer electrolyte to coat the surface of the catalyst particles with the polymer electrolyte, and then mixing a fluoro resin.

Preferable examples of the solvent to be used for production of the catalyst composition ink may be polar solvents such as alcohol shaving 1 to 6 carbon atoms, glycerin, ethylene carbonate, propylene carbonate, butyl carbonate, ethylene carbamate, propylene carbamate, butylene carbamate, acetone, acetonitrile, dimethylformamide, dimethylacetamide, 1-methyl-2-pyrrolidone, sulfolane and the like. The organic solvents may be used alone or in form of mixtures with water.

The electrolyte membrane-electrode assembly can be obtained by applying the paste obtained in such a manner for catalyst layer formation to one face side of the polymer electrolyte membrane preferably by screen printing, roll coater, or a comma coater at least once, preferably 1 to 5 times; applying the paste similarly to the other face side; and drying the paste; or thermally press-bonding the catalyst sheets (films) prepared from the paste for catalyst layer formation; and forming the catalyst layers on both faces of the polymer electrolyte membrane.

The electrolyte membrane for the fuel cell of the present invention is advantageously used for a structure body of a high power fuel cell, since the pores of the porous membrane can be filled with the electrolyte by easier process, the membrane has high size precision, and the membrane is not substantially swollen by water or methanol.

The electrolyte membrane-electrode assembly is advantageously used for a structure body of a high power fuel cell, since the assembly has high size precision, and the assembly is not substantially swollen by water or methanol, and.

The fuel cell can be obtained by using the above-mentioned electrolyte membrane-electrode assembly as constituent component.

### EXAMPLES

Hereinafter, the present invention will be described more in details along With Examples and Comparative Examples, however the scope of the invention is not limited by these Examples. In Examples and Comparative. Examples, % stands for % by weight andpart(s) stands for part(s) byweight unless stated otherwise.

### Example I

### Preparation Example of Substrate I-1

S-BPDA as a tetracarboxylic acid component and DADE as a diamine component were used. A mixture of them at 0.998 mole ratio of DADE to s-BPDA was dissolved in NMP such that total of the monomer components was a concentration of 9.8% by weight, and polymerized at 40° C. for 15 hours, to obtain a polyimide precursor. The solution viscosity of the polyimide precursor solution was 1,000 poise.

The resulting polyimide precursor solution was poured into a specularly polished SUS plate such that a thickness of the solution was about 150 μm. The solution was covered with a finely porous membrane made of an olefin, as a solvent substitution rate adjustment material, having a gas permeability of 550 s/100 cc (UP-3025, manufactured by Ube Industries, Ltd.) in a wrinkle-free manner. The resulting laminate was immersed in methanol for 7 minutes and solvent replacement was carried out through the solvent substitution rate adjustment material to precipitate the polyimide precursor and make the formed membrane porous.

The precipitated polyimide precursor porous membrane was immersed in water for 15 minutes and then separated from the specularly polished SUS plate and the solvent substitution rate adjustment material. While being fixed by a pin tenter, the membrane was heated at 320° C. for 15 minutes in atmospheric air, thereafter, to obtain a porous polyimide membrane A-1. The imidation ratio of the porous polyimide membrane A-1 was 80%. The porous polyimide membrane A-1 had physical pores in both faces, and the pores penetrate through the membrane in the direction of the cross-section thereof. Further, the porous polyimide membrane A-1 had a three-dimensional network structure as the inner pore structure composed of polyimide and the voids.

The porous polyimide membrane A-1 had the following properties according to the measurements carried out as described below: the average pore diameter: 0.3 μm; the porosity: 45%; the thickness: 33 μm; the heat resistant temperature: 280° C.; and thermal shrinkage ratio: 0.34%.

<Average Pore Diameter>

Measurement was carried out by using a mercury pressurizing type pore diameter distribution measurement apparatus (Autoscan 60+500 Porosimeter, manufactured by Yuasa Ionics Inc.). 0.1 g to 0.3 g of a sample was dried at 250° C. for 60 minutes, and the sample adsorbed with gas was subjected to the measurement by the apparatus. Hereinafter, the measurement conditions will be shown. That is, a sample cell: a small cell (10 φ×30 cm); a measurement range: the entire range; a measurement extent: pore diameter of 400 μm to 3.4 nm (pressure range: 0.1 to 60,000 PSIA); a calculation range: pore diameter of 400 μm to 3.4 nm; a mercury contact angle: 140°; a mercury surface tension: 480 dyn/cm; a measurement cell volume: 0.5 cm³; and the number of the measurement times: once.

<Porosity>

The thickness and the weight of the porous membrane A-1 cut into a predetermined shape were measured, and the porosity was calculated from weight per unit of surface area according to the following equation X. In the equation X, S represents the surface area of the porous membrane; d: the membrane thickness; w: the measured weight; and D: the density of the polyimide, wherein the density of the polyimide was set to be 1.34.
Porosity=s×d×D/W×100 (equation X)
<Thickness>

The thickness of the porous membrane was measured by a contact type measurement method.

<Heat Resistant Temperature>

As described above, the heat resistant temperature means the glass transition temperature (Tg) evaluated by, for example, DSC. The differential thermal analysis was carried out by using a measurement apparatus (SSC 5200 TGA 320, manufactured by Seiko Instruments Inc.) at a temperature increasing condition of 20° C./min in nitrogen.

<Thermal Shrinkage Ratio>

A sample having gauges in predetermined length was kept still in non-fixation state in an oven set at 105° C. for 8 hours, and the size was measured after the sample was taken out. The thermal shrinkage ratio was calculated according to the following equation Y. In the equation Y, L1 represents the membrane size after it was taken out of the oven and L0: the initial membrane size.
Thermal shrinkage ratio=L1/L0×100 (equation Y)

### Example I-1

The porous polyimide membrane A-1 obtained in the above-mentioned manner was used as a porous substrate to form an electrolyte membrane. As a first polymer to fill pores of the membrane with, the following AAVS type polymer was used to obtain a membrane B-1.

<AAVS Type>

An aqueous solution containing 79 mol % of acrylic acid, 20 mol % of sodium vinylsulfonate, and 1 mol % of divinylbenzene as a cross-linking agent was prepared such that concentration of acrylic acid, sodium vinylsulfonate and divinylbenzene was 70 wt %. A water-soluble azo type initiator; 2,2′-azobis(2-amidinopropane)dihydrochloride (hereinafter, abbreviated as “V-50”); was added to the solution at a ratio of 1% by mole to 100% by mole of the total of the acrylic acid and vinylsulfonate, to obtain a solution. The substrate A-1 was immersed in the solution, and visible light was radiated to the substrate for 6 minutes. Then, the substrate was heated at 50° C. for 18 hours in an oven.

And then, the excess polymer on the surface of the membrane was removed. After ion exchange using a considerably excess amount of 1 N hydrochloric acid, the membrane was sufficiently washed and further dried at 50° C. in the oven, to obtain a membrane B-1. The weight of the membrane B-1 was measured after drying to calculate the polymerization quantity by comparison with the weight before the polymerization. The polymerization quantity was 0.1 to 1.5 mg/cm². The membrane thickness after the polymerization was about 35 μm.

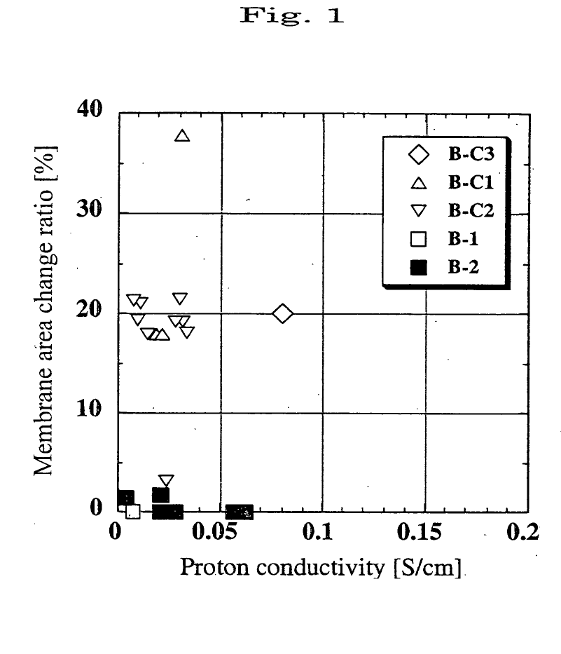

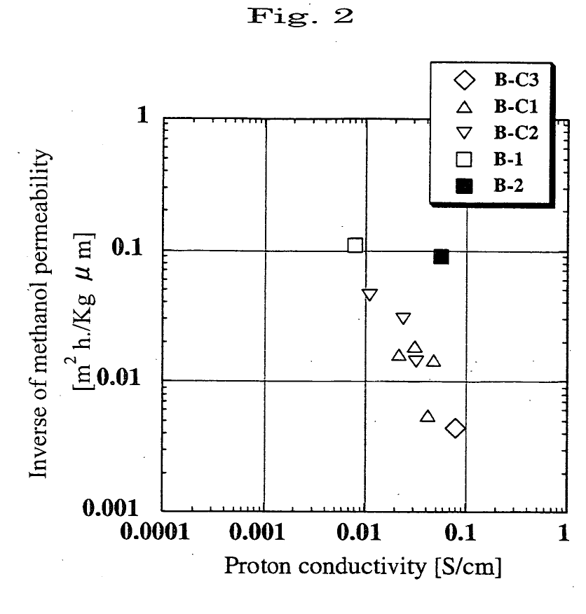

The obtained membrane B-1 was subjected to 1) measurement of <change in surface area>B as described hereinafter; 2) evaluation of methanol permeability; and 3) measurement of proton conductivity. The respective measurement methods or the evaluation method are described below. The obtained results are shown in FIGS. 1 and 2. FIG. 1 is a graph of the results of measurement of change in surface area and proton conductivity. FIG. 2 is a graph of the results of the methanol permeability evaluation and the results of the proton conductivity measurement.

<Measurement of Change in Surface Area of Membrane>

The change in surface area of the produced electrolyte membranes was measured as follows:

In order to measure the change in membrane surface area before and after the filling with the electrolyte membrane and the change in membrane surface area of the filled membrane following the swelling and shrinkage of the polymer, at first the lengths of the dried porous polyimide membrane in the x-direction and y-direction were measured according to a standard (condition 1). Next, with respect to the membrane after measurement, filling and polymerization of the electrolyte were carried out, and then after subjected to washing and ion-exchange treatment, the resulting membrane was immersed in water at 25° C. and kept overnight. The lengths of the electrolyte membrane in the completely swollen state in the x-direction and y-direction were measured (condition 2). After that, the lengths were similarly measured after the membrane was sufficiently dried in a drier at 50° C. (condition 3).

The surface area x×y was calculated from the results of the measurements, and the change in surface area was calculated according to the following equations:

Change in surface area before and after the filling of the electrolyte membrane: A (%)
A=[surface area (condition 1)−surface area (condition 3)]×100/surface area (condition 1):

Change in surface area of the electrolyte membrane between dry state and wet state: B (%)
B=[surface area (condition 2)−surface area (condition 3)]×100/surface area (condition 3).
<Methanol Permeability>

A permeability test (liquid/liquid system) was carried out by a diffusion cell, and the methanol permeability was evaluated. At first, after an object membrane to be measured was immersed in ion exchanged water to swollen the membrane, the resulting membrane was set in the cell. Ion exchanged water was poured into both of the permeation side and the supply side of MeOH, and the cell was stabilized in a thermostat for 1 hour. Next, methanol was supplied to the supply side to produce an aqueous 10% methanol solution to start the test. After every predetermined period, the solution in the permeation side was sampled and the methanol concentration was measured by gas chromatography to trace the concentration alteration, and the permeation flow rate, permeation coefficient and diffusion coefficient of methanol were calculated. The measurement was carried out at 25° C. to evaluate the methanol permeability.

<Proton Conductivity>

Electrodes were brought into contact with the front and the rear faces of the filling membrane in 100% wet state at a room temperature (25° C.). The resulting membrane was fixed by sandwiching it between heat resistant resin (polytetrafluoroethylene) plates, to measure the proton conductivity.

The membrane to be measured was washed in an aqueous 1 N hydrochloric acid solution by ultrasonic wave application for 5 minutes. The membrane was washed three times in ion-exchanged water by ultrasonic wave application, and then left still in the ion exchanged water. The membrane swollen in the water was taken out and put on a heat resistant resin (polytetrafluoroethylene) plate, brought into contact with platinum plate electrodes in the front and the rear faces, sandwiched between the heat resistant resin (polytetrafluoroethylene) plates and fixed by four screws. Alternating current impedance was measured by using an impedance analyzer (Impedance Analyzer HP 4194A, manufactured by Hewlett-Packard Development Company, L.P.), and the resistance value was read from call-call plots, to calculate the proton conductivity.

### Example I-2

Instead of AAVS type as used in Example I-1, the following ATBS type was used to obtain a membrane B-2.

<ATBS Type>

An aqueous solution was prepared by diluting a monomer mixture containing 99 mol % of 2-acrylamido-2-methylpropanesulfonic acid (hereinafter, abbreviated as ATBS) and 1 mol % of a cross-linking agent, methylenebis (acrylamide) with water to 50% by weight, and 1 mol % of a water-soluble azo-type initiator V-50 was added to the mixture of ATBS and methylenebis (acrylamide) based on 100 mol % of the mixture of ATBS and methylenebis(acrylamide), to obtain a solution. The substrate A-1 was immersed in the solution. After visible light was radiated to the substrate for 6 minutes, the resulting substrate was heated at 50° C. in an oven for 18 hours.

And then, the excess polymer remaining on the surface of the formed membrane was removed. The formed membrane was ion exchanged using a considerably excess amount of 1N hydrochloric acid and sufficiently washed with distilled water, and dried at 50° C. in an oven, to obtain the membrane B-2. After the drying, the weight of the membrane B-2 was measured and the polymerization degree was calculated by comparison of the weight with that before polymerization. The polymerization degree was 0.1 to 1.5 mg/cm². The membrane thickness after the polymerization was about 35 μm.

A membrane B-2 was also subjected to 1) measurement of <change in surface area>B;.2) evaluation of methanol permeability; and 3) measurement of proton conductivity, as described in Example I-1. The obtained results are shown in FIGS. 1 and 2.

### Comparative Example I-1

A membrane B-C2 was obtained in a manner similar to Example I-1, except that a porous polytetrafluoroethylene membrane (membrane thickness: 70 μm; pore diameter: 100nm) was used instead of the substrate A-1 of Example I-1.

### Comparative Example I-2

A membrane B-C2 was obtained in a manner similar to Example I-1, except that a porous polytetrafluoroethylene membrane (membrane thickness: 70 μm; pore diameter: 50 nm) was used instead of the substrate A-1 of Example I-1.

### Comparative Example I-3

Nafion 117 was used instead of the membrane B-1 obtained in Example I-1 (membrane B-C3).

With respect to the membranes B-C1 to B-C3, similarly to the membranes B-1 and B-2, 1) measurement of <change in surface area>B; 2) evaluation of methanol permeability; and 3) measurement of proton conductivity were carried out. The obtained results are shown in FIGS. 1 and 2.

FIG. 1 showed that the membranes B-1 and B-2 using the substrate A-1 according to the present invention exhibit little change in surface area and that measurement points were found at approximately on the axis of abscissas. Accordingly, FIG. 1 showed that the membranes B-1 and B-2 obtained by using the substrate A-1 have less change in surface area than the membranes B-C1 to B-C3 obtained without using the substrate of the present invention.

Also, FIG. 2 showed that the membranes B-1 and B-2 using the substrate A-1 according to the present invention have high proton conductivity and low methanol permeability, thus satisfying the properties required for an electrolyte membrane.

### Example II

The methanol permeability, proton conductivity, and change in surface area of the resulting electrolyte membrane were evaluated in a manner similar to Example I, as follows:

### Reference Example II-1

A polyimide precursor NMP solution which contained 3,3′,4,4′-biphenyltetracarboxylic acid dianhydride and oxydianiline at 0.998 mole ratio, such that a concentration of total of the monomer components was 9.0% by weight, was poured into a specularly polished SUS plate. The solution was covered with a finely porous membrane made of an olefin (UP-3025, manufactured by Ube Industries, Ltd.) as a solvent substitution rate adjustment material. The resulting laminate was immersed in methanol and successively in water, and then heated at 320° C. in atmospheric air, to obtain porous polyimide membrane having the following properties. The thickness: 15 μm; the porosity: 33%, the average pore diameter: 0.15 μm; and gas permeability: 130 s/100 ml.

### Comparative Example II-1

A porous polyimide membrane obtained in Reference Example II-1 which was immersed in acetone once and then in primary water to temporarily make the membrane hydrophilic was immersed in an aqueous monomer solution produced by properly dissolving acrylamidomethylpropylsulfonic acid (ATBS), methylenebis(acrylamide) and as a reaction initiator V-50 (commercial name; manufactured by Toagosei Co., Ltd.) in water. After being immersed for a sufficient time, the porous membrane was taken out, sandwiched by glass plates, and exposed to UV radiation, to polymerize the monomer filled in pores of the membrane and obtain an electrolyte membrane. The produced electrolyte membrane was washed with flowing water for about 3 minutes, and the excess polymer adhering to both surfaces of the membrane was removed to make the membrane smooth. The obtained membrane was further washed by primary water by ultrasonic wave application.

The resulting membrane was evaluated after the same measurements were repeated 5 times. The average values are as follows:
The reciprocal number of methanol permeability coefficient: 0.03 m²h/kgμm;
the proton conductivity: 1.4×10⁻² S/cm;
change in surface area A: 0%;
change in surface area B: 0%; and
the membrane thickness:15 μm (in dry state), 16 μm (in wet state).

However, the electrolyte membrane obtained by the above-mentioned steps was found that the membrane had unevenness of electrolyte filling state, which was apparently observed by visual examination. The amount of the electrolyte filled in the membrane was found uneven, 14 to 31% on the basis weight ratio.

### Example II-1

A hybrid electrolyte membrane was obtained in a manner similar to Comparative Example II-1, except that instead of UV radiation, the polymerization was carried out by keeping the membrane in a drying apparatus at 50° C. for 12 hours.

The resulting membrane was evaluated after the same measurements were repeated 3 times. The average values are as follows:
The reciprocal number of methanol permeability coefficient: 0.44 m²h/kgμm;

the proton conductivity: 2.0×10⁻² S/cm;
change in surface area A: 0%;
change in surface area B: 0%; and
the membrane thickness: 15 μm (in dry state), 16 μm (in wet state)

The visual examination apparently found that the filling unevenness of the filling material was improved. The amount of the filling electrolyte was 20 to 25% with considerably suppressed unevenness, even though the same experiments were carried out 10 times.

### Example II-2

After the same steps as those of Example II-1 were carried out, a hybrid electrolyte membrane was obtained by repeating the immersion of the membrane in monomer solution with a concentration in a range 30 to 50% by weight as shown below, followed by thermal polymerization. As a result, without causing filling unevenness of the filling material, the filling ratio of the electrolyte could be controlled.
1st time: monomer concentration 50% by weight, electrolyte filling ratio: 25.5% by weight;
2nd time: monomer concentration 50% by weight, electrolyte filling ratio: 41.5% by weight;
3rd time: monomer concentration 30% by weight, electrolyte filling ratio: 43.1% by weight;
4th time: monomer concentration 40% by weight, electrolyte filling ratio: 47.0% by weight; and
5th time: monomer concentration 40% by weight, electrolyte filling ratio: 47.4% by weight.

On completion of the 1st time polymerization, the methanol permeability and proton conductivity were measured to find they were similar to those of Example II-1.

Further, the change in surface area A and the change in surface area B were both 0%, and the membrane thickness was 15 μm (in dry state) and 16 μm (in wet state).

### Example II-3

After the same steps as those of Example II-1 were carried out, a hybrid electrolyte membrane was obtained by repeating the immersion of the membrane in monomer solution with a concentration in a range 30 to 50% by weight as shown below, followed by thermal polymerization. As a result, without causing filling unevenness of the filling material, the filling ratio of the electrolyte could be controlled.
1st time: monomer concentration 50% by weight, electrolyte filling ratio: 25.9% by weight;
2nd time: monomer concentration 50% by weight, electrolyte filling ratio: 46.2% by weight; and
3rd time: monomer concentration 30% by weight, electrolyte filling ratio: 45.8% by weight.

On completion of the 1st time polymerization, the methanol permeability and proton conductivity were measured to find they were similar to those of Example II-1.

Further, the change in surface area A and the change in surface area B were both 0% on completion of the 3rd polymerization and the membrane thickness was 15 μm (in dry state) and 16 μm (in wet state).

### Example II-4

After the same steps as those of Example II-1 were carried out, a hybrid electrolyte membrane was obtained by repeating the immersion of the membrane in monomer solution with a concentration in a range 30 to 50% by weight as shown below, followed by thermal polymerization. As a result, without causing filling unevenness of the filling material, the filling ratio of the electrolyte could be controlled.
1st time: monomer concentration 50% by weight, electrolyte filling ratio.: 26.0% by weight,
2nd time: monomer concentration 30% by weight, electrolyte filling ratio: 30.4% by weight, and
3rd time: monomer concentration 40% by weight, electrolyte filling ratio: 34.3% by weight.

On completion of the 1st time polymerization, the methanol permeability and proton conductivity were measured to find they were similar to those of Example II-1.

Further, the change in surface area A and the change in surface area B were both 0% oncompletion of the 3rd polymerization, and the membrane thickness was 15 μm (in dry state) and 16 μm (in wet state).

### Example II-5

A fuel cell was produced by using the hybrid electrolyte membrane obtained in Example II-1, and electric power generation was carried out using the fuel cell.

1) Production of Electrolyte Membrane-Electrode Assembly (MEA)

0.37 g of carbon black (XC-72) pulverized in an agate mortar was mixed with 4.0 g of isopropanol and sufficiently dispersed by stirring and ultrasonic wave application. Then, 0.14 g of a commercially available polytetrafluoroethylene (PTFE) dispersion was further added thereto. The resulting mixture was stirred for about 1 minute, to obtain a paste for a diffusion layer.

The paste for a diffusion layer was applied to carbon paper (manufactured by Toray Industries, Inc.) separately 3 times by a screen printing method, dried in the air, and then calcined at350° C. for 2 hours, to obtain the carbon paper having the diffusion layer.

Carbon black carried with platinum 46.1% by weight (TEC10E50E, manufactured by Tanaka Kikinzoku Group) was mixed with an equal amount of ion-exchanged water. Then, a commercially available 5% Nafion solution was further added thereto. The resulting mixture was subjected to and ultrasonic wave application for 10 minutes. Then, a proper amount of PTFE dispersion was added thereto, to obtain a paste for catalyst layer formation. The paste was applied to the above-mentioned carbon paper having the diffusion layer separately 3 times by the screen printing method, and dried in the air, to form a gas diffusion electrode.

The foregoing diffusion electrode and the electrolyte membrane obtained in Example II-1 were contacted with each other at 130° C. and 2 MPa for 1 minute by using a hot press, to obtain MEA. The Pt amount in the electrode was 0.22 mg Pt/cm² for the anode and 0.23 mg Pt/cm² for the cathode.

2) Electric Power Generation by Fuel Cell

The produced MEA was assembled in a fuel cell with an electrode surface area of 5 cm² manufactured by Electrochem Co., Ltd. (U.S.A.).

Then, electric power was generated in the power generation conditions: the cell temperature: 60° C.; the anode temperature: 58° C.; the cathode temperature: 40° C.; and hydrogen and oxygen were used for the combustion gases.

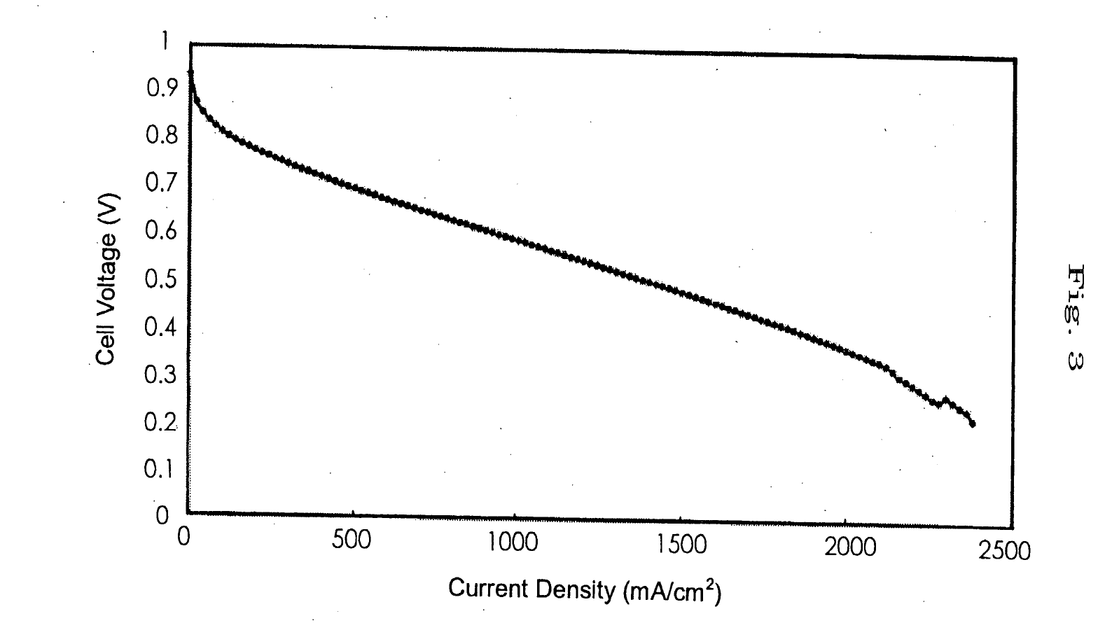

Accordingly, it is apparently found from FIG. 3, which shows the correlation of the electric current density-cell voltage (I-V curve), that 2.0 A/cm² or higher of current density was generated.

### Example II-6

A direct methanol fuel cell was produced by using the hybrid electrolyte membrane obtained in Example II-1, and electric power generation was carried out using the fuel cell.

1) Production of Electrolyte Membrane-Electrode Assembly (MEA)

0.37 g of carbon black (XC-72) pulverized in an agate mortar was mixed with 4.0 g of isopropanol and sufficiently dispersed by stirring and ultrasonic wave application. Then, 0.14 g of a commercially available polytetrafluoroethylene (PTFE) dispersion was further added thereto. The resulting mixture was stirred for about 1 minute, to obtain a paste for a diffusion layer.

The paste for a diffusion layer was applied to carbon paper (manufactured by Toray Industries, Inc.) separately 3 times by a screen printing method, dried in the air, and then calcined at350° C. for 2 hours, to obtain the carbon paper having the diffusion layer.

Carbon black carried with platinum 46.1% by weight (TEC10E50E, manufactured by Tanaka Kikinzoku Group) was mixed with an equal amount of ion-exchanged water. Then, a commercially available 5% Nafion solution was further added thereto. The resulting mixture was subjected to stirring and ultrasonic wave application for 10 minutes. Then, a proper amount of PTFE dispersion was added thereto, and stirred, to obtain a paste for catalyst layer formation. The paste was applied to the above-mentioned carbon paper having the diffusion layer separately 3 times by the screen printing method, and dried in the air, to form a gas diffusion electrode to be used for an oxygen electrode.

Carbon black carried with platinum 32.7% by weight and ruthenium 16.9% by weight (TEC66E50, manufactured by Tanaka Kikinzoku Group) was mixed with an equal amount of ion-exchanged water. Then, a commercially available 5% Nafion solution was further added thereto. The resulting mixture was stirring and ultrasonic wave application for 10 minutes. After that, a proper amount of PTFE dispersion was added thereto, and stirred, to obtain a paste for catalyst layer formation. The paste was applied to the above-mentioned carbon paper having the diffusion layer separately 3 times by the screen printing method, and dried in the air, to form a gas diffusion electrode to be used for a methanol electrode.

The foregoing diffusion electrodes and the electrolyte membrane obtained in Example II-1 were contacted with each other at 130° C. and 2 MPa for 1 minute by using a hot press, to obtain MEA. The catalyst amount in the electrode was 1.6 mg/cm² for the anode and 1.03 mg/cm² for the cathode.

2) Electric Power Generation by Fuel Cell

The produced MEA was assembled in a fuel cell with an electrode surface area of 5 cm² manufactured by Electrochem Co., Ltd. (U.S.A.).

Then, electric power was generated in the power generation conditions: the cell temperature: 50° C.; supply of an aqueous 3 mole/L methanol solution at 10 mL/min to the anode; and supply of dry oxygen at 1 L/min flow rate to the cathode.

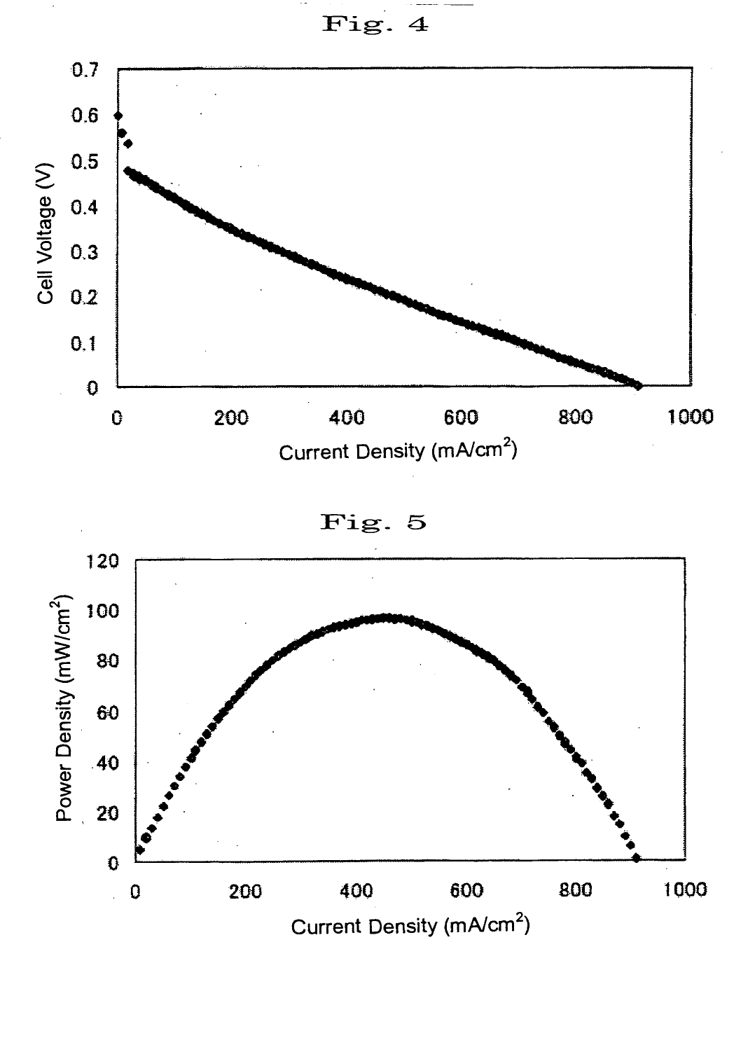

Accordingly, it is apparently found from FIG. 4 showing the correlation of the electric current density-cell voltage (I-V curve) and FIG. 5 showing the correlation of the current density-output density (I-W curve) that 90 mW/cm² or higher of a power density of was generated.

1. An electrolyte membrane comprising a porous substrate, wherein pores of the substrate are filled with a first polymer having proton conductivity, and the porous substrate is comprised of a second polymer which is at least one selected from the group consisting of polyimides and aromatic polyamides,
wherein the porous substrate has a network structure which is composed of polymer phase and void phase in inside thereof and forming microscopic continuous holes, and the porous substrate has a porous structure in both surfaces, and
wherein the porous substrate has an average pore diameter of 0.01 to 1 μm.

2. The electrolyte membrane according to claim 1, wherein the porous substrate is comprised of at least one selected from aromatic polyimides.

3. The electrolyte membrane according to claim 1, wherein the porous substrate is comprised of at least one selected from aromatic polyamides.

4. The electrolyte membrane according to claim 1, wherein the porous substrate has an average pore diameter: 0.01 to 1 μm; a porosity: 20 to 80%, and a thickness: 5 to 300 μm.

5. The electrolyte membrane according to claim 1, wherein the porous substrate has a heat resistant temperature of 200° C. or higher and a thermal shrinkage ratio of ±1% or less in case of thermal treatment at 105° C. for 8 hours.

6. (canceled)

7. The electrolyte membrane according to claim 1, wherein one end of the first polymer is bound to the inner surface of the pores of the substrate.

8. The electrolyte membrane according to claim 1, wherein the pores of the substrate are further filled with a third polymer having proton conductivity.

9. An electrolyte membrane comprising a porous substrate, wherein pores of the substrate are filled with a first polymer having proton conductivity, the porous substrate is comprised of a second polymer which is at least one selected from the group consisting of polyimides and aromatic polyamides, and the porous substrate has a ratio of change in surface area of about 1% or less between the dry state and the wet state at 25° C.,
wherein the porous substrate has a network structure which is composed of polymer phase and void phase in inside thereof and forming microscopic continuous holes, and the porous substrate has a porous structure in both surfaces, and
wherein the porous substrate has an average pore diameter of 0.01 to 1 μm.

10. The electrolyte membrane according to claim 9, wherein the electrolyte membrane has a proton conductivity of not lower than 0.001 S/cm and not higher than 10.0 S/cm at 25° C. and 100% humidity.

11. A fuel cell comprising the electrolyte membrane according to claim 1.

12. A solid polymer fuel cell comprising the electrolyte membrane according to claim 1.

13. A direct methanol solid polymer fuel cell comprising the electrolyte membrane according to claim 1.

14. A method for producing an electrolyte membrane which comprises a porous, polyimide or aromatic polyamide substrate filled with an electrolytic substance, wherein the electrolytic substance is a monomer composing a polymer having proton conductivity; and the method has a step of filling the monomer into pores of the membrane, and heating the monomer to polymerize the monomer,
wherein the porous substrate has a network structure which is composed of polymer phase and void phase in inside thereof and forming microscopic continuous holes, and the porous substrate has a porous structure in both surfaces, and
wherein the porous substrate has an average pore diameter of 0.01 to 1 μm.

15. The method according to claim 14, wherein after the step of heating the monomer to polymerize the monomer, the method further repeats the steps of filling and heating at least once, thereby filling ratio of a filling material being controlled.

16. The method according to claim 14 comprising a combination of the step of heating the monomer to polymerize, and one step selected from the following (X- 1) to (X-4) steps or combinations of two steps, or three, or all of these steps, thereby filling the pores of the membrane with the electrolytic substance; and/or after the step of filling the pores of the membrane with electrolytic substance, and following (Y-1) step and/or (Y-2) step:
(X-1) a step of making the porous membrane hydrophilic and immersing the porous membrane in a monomer or its solution;
(X-2) a step of adding a surfactant to a monomer or its solution to produce an immersion solution and immersing the porous membrane in the immersion solution;
(X-3) a step of reducing pressure in the state that the porous membrane is immersed in a monomer or its solution;
(X-4) a step of radiating ultrasonic wave in the state that the porous membrane is immersed in a monomer or its solution; and
(Y-1) a step of bringing a porous substrate for absorbing the electrolytic substance into contact with both surfaces of the porous membrane; and
(Y-2) a step of removing the electrolytic substance adhering to both surfaces of the porous membrane by a smooth material.

17. A method for producing an electrolyte membrane which comprises a porous, polyimide or aromatic polyamide substrate filled with an electrolytic substance, wherein the electrolytic substance is a monomer composing a polymer having proton conductivity, and the method comprises a step of adding a surfactant to the monomer or its solution to produce an immersion solution; a step of heating the monomer to polymerize the monomer,
wherein the porous substrate has a network structure which is composed of polymer phase and void phase in inside thereof and forming microscopic continuous holes and the porous substrate has a porous structure in both surfaces, and
wherein the porous substrate has an average pore diameter of 0.01 to 1 μm.

18. The method according to claim 14, wherein the porous membrane is a material which is not substantially swollen by methanol or water.

19. The method according to claim 14, wherein a radical polymerization initiator is further contained in the monomer or the solution, in the step of adding the surfactant.

20. The method according to claim 14, wherein the electrolytic substance filled in the pores has proton conductivity and is provided with a cross-linked structure by the step of heating the monomer to polymerize.

21. The method according to claim 14, wherein the electrolytic substance filled in the pores has proton conductivity and is chemically bound to the interface of the porous polyimide membrane by the step of heating the monomer to polymerize.

22. The method according to claim 14, wherein the electrolytic substance forms an electrolyte membrane having pores filled with the proton conductive polymer.

23. The method according to claim 14, wherein the polyimide contains 3,3′,4,4′-biphenyltetracarboxylic acid dianhydride as a tetracarboxylic acid component, and oxydianiline as a diamine component, respectively.

24. An electrolyte membrane for a fuel cell,
which comprises a porous, polyimide or aromatic polyamide substrate, having an average pore diameter of 0.01 to 1 μm, filled with an electrolytic substance wherein the porous substrate has a network structure composed of polymer phase and void phase in inside thereof and forming microscopic continuous holes, and the porous substrate has a porous structure in both surfaces,
having no lower than 0.001 S/cm and no higher than 10.0 S/cm of a proton conductivity at 25° C. in 100% humidity; no lower than 0.01 m²h/kgμm and no higher than 10.0 m²h/kgμm of a reciprocal number of methanol permeability at 25° C.; and no higher than 1% of a ratio of change in surface area between dry state and wet state at 25° C.

25. The electrolyte membrane for a fuel cell according to claim 24, wherein the polyimide contains 3,3′,4,4′-biphenyltetracarboxylic acid dianhydride as a tetracarboxylic acid component, and oxydianiline as a diamine component, respectively.

26. An electrolyte membrane-electrode assembly comprising the electrolyte membrane for a fuel cell according to claim 24.

27. A fuel cell comprising the electrolyte membrane-electrode assembly according to claim 26.

28. The electrolyte membrane according to claim 1, wherein the polyimides are derived from biphenyltetracarboxylic acid dianhydrides as tetracarboxylic acid components and diamines selected from the group consisting of diamines represented by following general formula (1) to (3): [chemical structure]
